(19) United States
(12) Patent Application Publication
(10) Pub. No.: US 2026/0288827 A1
(43) Pub. Date: Sep. 24, 2026

(54) SYSTEM

(71) Applicant: SoftBank Group Corp., Tokyo (JP)

(72) Inventor: Yuuichi NAKASO, Tokyo (JP)

(73) Assignee: SoftBank Group Corp., Tokyo (JP)

(21) Appl. No.: 19/562,781

(22) Filed: Mar. 11, 2026

(30) Foreign Application Priority Data
Mar. 19, 2025 (JP) 2025-044911

(51) Int. Cl. G06F 16/3332; G06F 16/335; G06F 16/35

(52) U.S. Cl. CPC G06F 16/3334; G06F 16/337; G06F 16/35

(57) ABSTRACT

A system includes a processor that is configured to receive information from a user and analyze the received information using a natural language processing technique to extract one or more important keywords, input the extracted one or more keywords into a generative artificial intelligence model and generate a prompt sentence for identifying a related service, collect a selection history and a search history of the user, analyze the selection history and the search history using a machine learning algorithm, and organize and deepen criteria of the user, and analyze an emotion of the user using an emotion analysis engine, adjust the criteria based on the analyzed emotion, search for related information based on the adjusted criteria, and generate a prompt for inducing a specific action by the user.

### CROSS-REFERENCE TO RELATED APPLICATION

This application is based on and claims priority under 35 USC 119 from Japanese Patent Application No. 2025-044911 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision and recommendation systems often rely on static user input or simple rule-based filtering and therefore fail to accurately capture the user's true intent, latent criteria, and emotional context. In many cases, a user is not able to explicitly describe all relevant conditions, and the system cannot sufficiently organize or deepen the user's criteria from limited input or simple search and selection logs. Furthermore, known systems typically do not integrate natural language understanding, user behavior analysis, and emotion analysis in a unified processing flow. As a result, such systems are limited in their ability to generate prompts or guidance that effectively induce appropriate actions suited to the user's real needs and emotional state. There is thus a need for a system that can comprehensively analyze natural language input, user history, and emotional state, and that can dynamically refine user criteria and generate prompts capable of guiding the user toward suitable services and actions.

### SUMMARY

In order to solve the above-described problems, according to one aspect of the present invention, there is provided a system comprising a processor, wherein the processor is configured to receive information from a user and analyze the received information using a natural language processing technique to extract one or more important keywords. The processor is further configured to input the extracted one or more keywords into a generative artificial intelligence model and generate a prompt sentence for identifying a related service. In addition, the processor is configured to collect a selection history and a search history of the user, analyze the selection history and the search history using a machine learning algorithm, and organize and deepen criteria of the user. The processor is also configured to analyze an emotion of the user using an emotion analysis engine, adjust the criteria based on the analyzed emotion, search for related information based on the adjusted criteria, and generate a prompt for inducing a specific action by the user. By combining natural language processing, user behavior analysis, and emotion analysis in this integrated manner, the system can automatically determine related services from the content of the received information and generate prompts that are adapted not only to the user's explicit and implicit criteria but also to the user's emotional state, thereby enabling more effective guidance and recommendation.

The term “processor” refers to one or more hardware processing units, such as a central processing unit (CPU), graphics processing unit (GPU), digital signal processor (DSP), or other circuitry, and may include a combination of such units configured to execute instructions to implement the functions described in the claims.

The term “natural language processing technique” refers to any algorithm, model, or computational method for processing, analyzing, or understanding human language expressed in text or speech, including but not limited to tokenization, part-of-speech tagging, parsing, named entity recognition, intent detection, keyword extraction, and semantic analysis.

The term “important keyword” refers to a word, phrase, or token extracted from user-provided information that is determined, according to a predetermined criterion or model, to be relevant to identifying user intent, preferences, or a related service.

The term “generative artificial intelligence model” refers to a machine learning model configured to generate text or other content based on input data, examples of which include, but are not limited to, transformer-based language models, sequence-to-sequence models, and other generative models capable of producing prompt sentences or recommendations.

The term “prompt sentence” refers to a text string or natural language output generated by the generative artificial intelligence model and used to identify, query, or present a related service, or to induce a user to take a particular action.

The term “service” refers to any function, operation, application, content, or external or internal system that can be provided, invoked, or recommended to the user, including but not limited to web services, software functions, commercial services, and information provision services.

The term “selection history” refers to data indicating items, options, services, or content that have been selected or chosen by the user in past interactions with the system.

The term “search history” refers to data indicating search queries, criteria, or operations that have been input or executed by the user in past interactions with the system.

The term “machine learning algorithm” refers to any algorithm, model, or computational technique that learns patterns or relationships from data, including but not limited to supervised learning, unsupervised learning, reinforcement learning, and deep learning methods, and that is applied to analyze the user's selection history and search history.

The term “criteria of the user” refers to explicit or implicit conditions, preferences, constraints, or requirements used to evaluate, filter, or select services or information relevant to the user.

The term “organize and deepen criteria of the user” refers to processing that structures, refines, supplements, or clarifies the user's criteria, including deriving additional or more specific conditions from the user's past behavior and input.

The term “emotion analysis engine” refers to a software and/or hardware component configured to analyze user-related data, such as text, voice, or behavior, to estimate or classify an emotional state, sentiment, or affective response of the user.

The term “emotion of the user” refers to an estimated emotional state, sentiment, or affective condition of the user, such as satisfaction, dissatisfaction, interest, anxiety, or enthusiasm, as determined by the emotion analysis engine.

The term “related information” refers to data, content, or service-related information that is determined to be relevant to the user based on the adjusted criteria and that can be presented, recommended, or used as a basis for generating a prompt.

The term “prompt” refers to a message, indication, or instruction presented to the user, typically in natural language, for guiding, encouraging, or inducing the user to take a specific action or to interact with a service.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

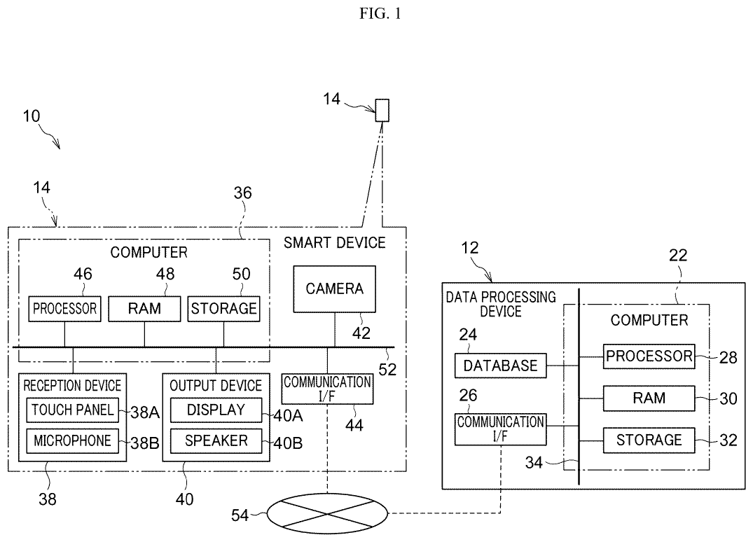

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

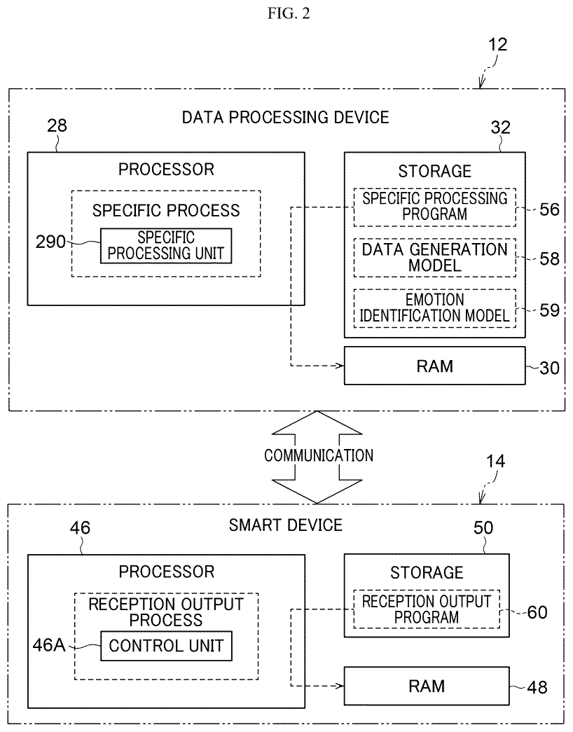

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information retrieval systems that accept user inputs in the form of fixed fields or free-form natural language suffer from several technical limitations at the level of computer operation. When the system receives only rigid, structured inputs, the user must translate an inherently ambiguous or evolving intent into predefined input elements, which leads to under-specified or poorly aligned search criteria. This misalignment causes the processor to generate inefficient query expressions, resulting in unnecessary scans of large data sets, suboptimal use of indices, and increased response latency. Conversely, when the system accepts unstructured natural language requests and applies only simple keyword extraction, the processor often produces noisy or incomplete search parameters, which again lead to excessive query breadth and redundant data transfers between the server and the terminal.

Furthermore, existing systems typically do not exploit user interaction signals and affective states at a system level to refine the internal representations used by the processor. User selection histories and search histories are often logged but not used in real time to reorganize or deepen the search criteria. As a result, the processor repeatedly executes similar broad queries, which places unnecessary computational load on the database engine, network stack, and rendering pipeline at the terminal. In addition, the absence of emotion-aware adaptation forces the system to treat all requests uniformly, even when the user's behavior indicates confusion, frustration, or satisfaction. This uniform treatment prevents the processor from dynamically adjusting display density, navigation flow, or follow-up prompts in a manner that reduces interaction steps and optimizes resource consumption.

Conventional systems also fail to integrate generative artificial intelligence models in a way that directly improves the technical operation of query generation and result presentation. Generative models are often used only to generate human-readable text, without constraining outputs to structured formats that can drive efficient query planning. This lack of structured integration causes additional parsing overhead and can produce ambiguous criteria, resulting in unstable query performance and unpredictable load on the information storage apparatus. Moreover, conventional client-server architectures do not adapt the layout and granularity of displayed information based on both machine-learned criteria and inferred emotional state, leading to unnecessarily large responses, repetitive page reloads, and inefficient use of bandwidth and rendering resources.

Accordingly, there is a need for a system and method in which a processor uses natural language processing, a generative AI model, learning-based refinement, and emotion-aware control in combination to (i) transform unstructured and structured user inputs into precise, structured criterion information, (ii) generate optimized query expressions that better exploit indices in an information storage apparatus, and (iii) adjust the structure and sequencing of display data so as to reduce computational load, network traffic, and interaction steps. Such a system should improve the overall efficiency, responsiveness, and robustness of the underlying computer system, rather than merely providing a different user interface experience.

The specific processing by the specific processing unit 290 of the data processing device 12 in Example 1 is realized by the following means.

The present invention provides a server comprising a processor configured to receive information from a user including natural language, to analyze the information by using natural language processing to extract important terms including candidate criteria, to generate a prompt sentence for input to a generative AI model based on the extracted important terms and the candidate criteria, to obtain structured criterion information from the generative AI model according to the prompt sentence, to generate a query sentence according to the structured criterion information, to execute a search process on an information storage apparatus having an index by using the query sentence to acquire information matching the structured criterion information, to generate display-structured information for split display of the acquired information and transmit the display-structured information to a terminal, to collect a selection history and a search history of the user, to execute learning processing to organize and detail the structured criterion information and automatically adjust the query sentence and the prompt sentence based on updated structured criterion information, and to analyze an emotional state of the user by using emotion analysis processing, adjust the structured criterion information and the display-structured information according to the emotional state, and generate a prompt to induce a specific action of the user. This enables the server to convert ambiguous natural language requests and heterogeneous interaction signals into machine-optimized, structured criteria that drive index-aware query generation and adaptive result presentation, thereby reducing redundant data access, lowering network and processing overhead, and improving the responsiveness and efficiency of the computer system as a whole.

The term “information” refers to data received from a user, including at least natural language text and optionally structured values, that expresses a request, condition, or intent to be processed by the system.

The term “natural language” refers to human language expressions, such as sentences or phrases, that are not restricted to predefined command syntax or fixed-form fields and that require linguistic analysis to extract machine-usable meaning.

The term “natural language processing” refers to computational techniques executed by a processor to analyze natural language, including operations such as tokenization, morphological analysis, part-of-speech tagging, syntactic parsing, semantic interpretation, and keyword extraction.

The term “important terms” refers to tokens, phrases, or linguistic units identified by natural language processing as being relevant to a user's intent or constraints, such as location, range, attribute, or preference descriptors.

The term “candidate criteria” refers to preliminary constraint elements derived from important terms and other user-provided signals, which represent possible conditions to be applied in subsequent search or retrieval processes.

The term “prompt sentence” refers to a machine-readable instruction sequence, expressed in natural or semi-structured language, that is constructed for input to a generative AI model and that specifies how the model should interpret user requests and format its output.

The term “generative AI model” refers to a data-driven computational model, such as a large-scale neural network, configured to generate text or structured outputs in response to input prompts, and trained using machine learning on large corpora of data.

The term “structured criterion information” refers to a machine-usable representation of search or decision criteria, expressed in a defined data structure such as key-value pairs or typed fields, derived at least in part from a generative AI model or other analysis.

The term “query sentence” refers to a machine-readable request expression, such as a database query or search command, that is generated based on structured criterion information and is used to retrieve matching data from an information storage apparatus.

The term “information storage apparatus” refers to a hardware and software combination, such as a database system or storage subsystem, that stores records and provides access operations for reading, writing, and searching data.

The term “index” refers to a data structure maintained by the information storage apparatus for accelerating retrieval operations by organizing references to stored records according to key attributes.

The term “acquire information” refers to the operation in which a processor obtains, from the information storage apparatus, one or more records or data items that satisfy conditions determined by the query sentence.

The term “display-structured information” refers to a data representation prepared for presentation on a terminal, which specifies layout units, pagination, ordering, and content elements for visual or interactive display of acquired information.

The term “split display” refers to a mode of presentation in which acquired information is divided into multiple display units, such as pages or segments, to control the volume of information shown at once and to support stepwise navigation.

The term “terminal” refers to an end-user computing device, such as a client device or user interface device, that receives display-structured information from the server and presents it to the user via an output interface.

The term “selection history” refers to logged data describing which items, options, or actions the user has selected or activated during prior interactions with the system.

The term “search history” refers to logged data describing prior search requests, query conditions, and associated user interactions previously executed by or on behalf of the user.

The term “learning processing” refers to computational procedures, including but not limited to machine learning algorithms, that analyze selection history, search history, or other signals to update internal models or parameters used to refine criterion information.

The term “organize and detail the structured criterion information” refers to operations that normalize, rank, add, or refine elements of criterion information, such as resolving ambiguities, introducing additional constraints, or adjusting value ranges.

The term “updated structured criterion information” refers to structured criterion information that has been modified by learning processing, user interaction feedback, or emotion analysis, and that is used for subsequent query generation.

The term “emotion analysis processing” refers to computational techniques for inferring a user's emotional state, such as sentiment, frustration, or satisfaction, from signals including natural language content, interaction patterns, or biometric indicators.

The term “emotional state” refers to an estimated affective condition of the user, represented in a machine-usable form, that is derived by emotion analysis processing and used to adapt system behavior.

The term “prompt to induce a specific action” refers to an output message or instruction generated by the processor, optionally with assistance from a generative AI model, that is designed to encourage the user to perform a targeted operation, such as refining criteria, selecting an item, or confirming a transaction.

The server executes the invention on a hardware platform that includes at least one central processing unit, a main memory, a non-volatile storage device, a network interface, and an optional hardware accelerator such as a graphics processing unit. The server runs a server-side operating system, an application framework, a natural language processing library, a database management system, and a generative AI inference engine. The terminal operates as a client device, for example a smartphone, a tablet, or a personal computer, comprising a processor, a memory, a display, an input interface, and a network interface, and executes a web browser or a dedicated client application. The user interacts with the terminal via the display and input interface to provide natural language requests and structured form inputs.

The server stores, in the non-volatile storage device, program modules implementing natural language processing, query generation, learning processing, emotion analysis, generative AI integration, and display structuring. The server loads these program modules into main memory and executes them on the processor. The server also maintains an information storage apparatus, implemented for example as a relational database engine running on the same machine or a separate storage server, which stores records and indices optimized for search operations. The server uses a database schema in which application data such as “properties,” “users,” “sessions,” and “interaction_logs” are stored in tables with columnar definitions including numeric, string, Boolean, and timestamp fields. The server defines composite indices over commonly queried fields, such as region, price range, feature flags, and floor number, to support efficient execution of equality and range predicates.

The terminal presents a user interface through the browser or client application. The terminal renders user interface components using markup and style languages and executes client-side logic using a scripting language. The terminal displays input widgets for structured search criteria (for example, area, maximum price, and specific features) and a text box for a natural language description. The user can input constraints such as “area: Shibuya,” “rent: under 100,000,” and “bath and toilet: separate,” or the user can type a free-form natural language phrase. The user can, for example, type the following prompt sentence: “Please search for rental properties in Shibuya with a monthly rent under 100,000 yen, a separate bath and toilet, and located on the second floor or higher.”

The terminal collects these inputs and transmits them to the server through the network interface using an application-layer protocol. The server receives the inputs and stores them temporarily in memory as data structures representing the user's request. The server applies a natural language processing pipeline to the portion of the input that is expressed in natural language. The server segments the input text into tokens, applies morphological analysis and part-of-speech tagging, identifies noun phrases and adjective phrases, and maps these linguistic units to semantic slots representing candidate criteria, such as geographic region, numeric thresholds, and Boolean feature conditions.

The server executes this natural language processing using a text processing library that implements tokenization, parsing, and named entity recognition. The server uses a trained statistical or neural part-of-speech tagger and a dependency parser to derive a syntactic structure for the user's sentence. The server applies pattern-based and statistical mapping from syntactic structures to domain-specific semantic frames. For example, the server maps an adjective phrase “under 100,000 yen” to a numeric attribute “maximum_rent=100000,” and the server maps a prepositional phrase “in Shibuya” to a location attribute “area =Shibuya.” The server stores these candidate criteria in an intermediate data structure as key-value pairs with attached confidence scores that quantify how likely each candidate criterion is correctly interpreted.

The server then constructs a prompt sentence for a generative AI model by embedding the important terms and candidate criteria into an instruction template. The server explicitly specifies, in the prompt sentence, that the generative AI model shall output a structured set of fields in a prescribed format. The server may, for example, generate a prompt sentence such as: “You are a real estate search assistant. From the following user request, extract and return the following items: area (string), maximum_rent (integer, in yen), bath_toilet_separate (boolean), and minimum_floor (integer). The user request is: ‘Please search for rental properties in Shibuya with a monthly rent under 100,000 yen, a separate bath and toilet, and located on the second floor or higher.’ Return only the extracted values and no additional explanation.”

The server supplies this prompt sentence, together with the user's natural language text, to the generative AI model. The server implements the generative AI model as a large-scale neural network, for example a transformer-based language model, comprising multiple self-attention layers, feed-forward layers, and embedding layers. The server loads the model parameters into memory and may offload tensor computations to a GPU to accelerate matrix multiplications and attention-score computations. The model has been trained in advance using supervised and unsupervised learning on large corpora, including domain-specific examples of requests and structured outputs.

The server processes the prompt sentence with the model by converting tokens into vector embeddings, computing attention weights across tokens, and performing layer-by-layer propagation through the network. The server configures the model to generate a structured output in a constrained format, such as a small set of labeled fields, by specifying decoding parameters and by including explicit formatting instructions in the prompt sentence. The server uses techniques such as beam search or top-k sampling to produce a stable and consistent output, and additionally may apply a post-decoding parser to enforce that the output conforms to the expected structure. This constrained generation reduces ambiguity and parsing overhead compared to unconstrained text generation, and thereby directly improves the reliability and speed of downstream query construction.

The server receives the structured criterion information from the generative AI model and parses it into internal data structures. The server validates that all required fields are present and that each value is within an allowable range, for example by verifying that numeric values are non-negative and that categorical fields match known domain values. The server may combine this AI-derived criterion information with structured form inputs provided by the user. In this combination, the server applies a rule-based priority scheme or a conflict resolution algorithm. For instance, the server may prioritize explicit form-field values over AI-inferred values when conflicts occur, or may merge them according to confidence scores previously attached. This integration yields finalized structured criterion information containing cleaned, consolidated search parameters.

The server generates a query sentence from the finalized structured criterion information. The server selects query templates based on combinations of criteria and substitutes parameter values into these templates. For example, when the criterion information includes area, maximum rent, and a Boolean feature, the server selects a query structure that includes equality and inequality conditions on indexed columns. The server orders the conditions in the query to align with the ordering of composite indices in the database schema, thereby guiding the database planner towards index-based retrieval instead of full table scans. The server's query-generation module applies heuristic or learned optimization rules, such as placing the most selective equality conditions first and using range conditions only on columns that are part of an index suffix.

The server forwards the query sentence to the information storage apparatus. The information storage apparatus parses the query, generates an execution plan, and uses indices to locate matching records. Because the server has limited the criterion information to well-structured, index-friendly conditions, the information storage apparatus can avoid scanning entire tables and instead navigate index trees or other specialized structures such as B-trees or hash indices. This yields reduced disk access, lower memory footprint, and shorter response time. The server receives from the information storage apparatus a set of records representing matched items, for example a set of property records with attributes such as identifier, location, price, floor number, size, and features.

The server transforms the retrieved records into display-structured information. The server partitions the records into display units, such as pages of a fixed number of items, and assigns an order based on relevance scores, user preferences, or learned ranking models. The server computes derived attributes, such as normalized scores or category labels, for each record. The server then constructs a display descriptor that specifies, for each display unit, which items are included, in which order, and with what level of detail. The server includes meta-information such as total number of results, current page index, and identifiers for fetching adjacent pages. The server transmits this display-structured information to the terminal through the network interface.

The terminal receives the display-structured information and uses it to render user interface elements. The terminal's processor decodes the received data into internal structures and constructs visual components corresponding to each item, including text fields, icons, and action buttons for details or selection. The terminal applies local styling instructions and layout algorithms to display the items within the constraints of the screen size and orientation. The user can scroll through the list, select an item to view details, or navigate between pages. The terminal may request subsequent display units from the server based on user actions, and the server can adjust the amount of data returned per request according to network conditions or device capabilities.

The server records, in an interaction log table, user selection history and search history. For each session, the server stores which items the user inspected, which items the user selected or bookmarked, which criteria the user used, and how the user modified those criteria over time. The server performs learning processing on this log data, for example by training a recommendation model or a criteria refinement model. The server may employ a gradient-boosted decision tree model or a feed-forward neural network that takes as input features such as past selected items, frequency of specific criteria, and temporal patterns of interaction. The server computes model parameters by minimizing a loss function that captures discrepancy between predicted and actual selections, using optimization algorithms such as stochastic gradient descent or its variants.

The server uses the learned model to reorganize and detail the structured criterion information. For example, when the user repeatedly narrows the price range or consistently selects items with certain features, the server adjusts future criterion information by automatically tightening price bounds or promoting those features as default constraints. The server may introduce additional derived constraints based on correlations observed in the training data, such as suggesting a minimum floor number when the user usually selects higher-floor units. These adjustments are applied before query generation, which results in queries that more closely match the user's latent preferences and reduce the number of irrelevant results returned by the information storage apparatus.

The server further performs emotion analysis processing on user-related signals. The server can analyze the textual content of the user's natural language requests and subsequent messages, using a sentiment analysis model, for example a neural network classifier trained to predict affective categories such as frustration, confusion, or satisfaction. The server may also consider interaction timing and event patterns, such as rapid changes of criteria or frequent back-and-forth navigation, as additional features. The server combines these features in a classifier model that outputs an estimated emotional state representation. The emotional state is stored as a vector of affective scores and is updated as the interaction progresses.

The server uses the emotional state to adapt both the structured criterion information and the display-structured information. If the emotional state indicates confusion, the server may simplify the display by reducing the number of items per page, highlighting key attributes, and generating explanatory messages. If the emotional state indicates satisfaction, the server may increase result density or offer advanced filters. The server can generate a prompt sentence, in natural language, that encourages the user to perform specific actions tailored to the emotional state, such as “Would you like to narrow the area to stations within ten minutes' walk?” or “You seem interested in properties with larger kitchens; shall we prioritize those?” The server may again use the generative AI model to compile these prompts based on the emotional state vector and the current criterion information, but constrains the output through templates that ensure clear and concise guidance.

The server's combination of natural language processing, constrained generative AI, learning-based refinement, and emotion-aware adaptation yields a technical improvement in the operation of the computer system. By converting unstructured natural language and interaction histories into structured, index-aware criteria, the server reduces the search space before query execution, lowers the volume of non-relevant data retrieved from the information storage apparatus, and decreases the average response time. The constrained prompt sentences and structured outputs of the generative AI model reduce parsing overhead and ambiguity, allowing the processor to avoid repeated error handling and clarification cycles. The learning processing over selection and search histories enhances query precision and ranking, which decreases the number of iterative searches the user must perform and thus reduces overall computational load and network usage. The emotion-aware display structuring further optimizes data transmission and rendering by tailoring the amount and type of content to the inferred user state, which leads to fewer redundant page transitions and more efficient use of terminal resources.

The server implements these processes using non-conventional data flows and control logic within the computer system. Rather than merely automating human decision steps, the server applies specific computational rules to reorder and constrain data, select indices, and schedule queries. The generative AI model is not simply invoked to generate text; instead, it is integrated as a structured criterion generator under strict prompts that define field-level outputs. The models are trained using labeled and unlabeled data with specified loss functions, and the server uses their outputs in algorithmic pipelines that are tuned for computational efficiency. This architecture results in concrete improvements in processing speed, accuracy of retrieved results, and utilization of storage and network bandwidth, thereby constituting an improvement to computer technology itself.

The system can be implemented in various embodiments. In one embodiment, the server and the information storage apparatus reside on a single physical machine, and the generative AI model runs locally using a hardware accelerator. In another embodiment, the server connects to a remote generative AI inference service over a secure network protocol, while maintaining local caches of model outputs and intermediate criteria to reduce latency. In yet another embodiment, the terminal runs an additional lightweight model or rule engine to pre-filter or summarize user inputs before transmission, thereby further reducing network traffic and server load. These and other variations in hardware configuration, model architecture, and software stack are encompassed by the invention, as long as the server, the terminal, and the user interact in the described manner to generate structured criterion information, optimized queries, and adaptive displays using natural language processing, generative AI models, learning processing, and emotion analysis.

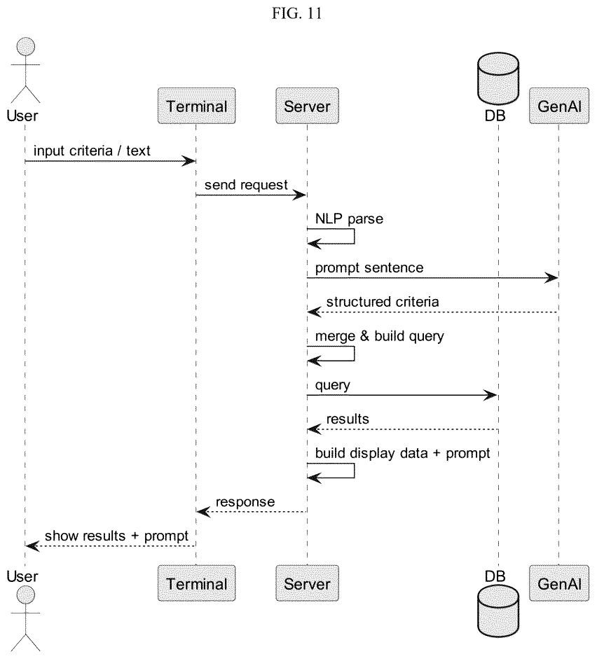

The following describes the processing flow using FIG. 11.

### Step 1

The user operates the terminal to input a request. The user opens an application or web page on the terminal and either fills in structured form fields (such as area, maximum rent, and property features) or types a natural language request into a text box. The input is human-readable text and structured values. The terminal collects these values from user interface elements, normalizes simple formats (for example, removing currency symbols or whitespace), and constructs an internal request object. The output of this step is a combined request object containing both structured criteria and raw natural language text.

### Step 2

The terminal transmits the combined request object to the server. The terminal serializes the request object into a machine-readable format, attaches metadata such as session identifiers and timestamps, and sends it via a network interface using a communication protocol. The input of this step is the combined request object from Step 1; the output is a network message delivered to the server that encodes all user-provided fields and free-text content.

### Step 3

The server receives and parses the user request. The server accepts the network message through a server-side interface, checks message integrity, and deserializes the request into in-memory data structures. The server separates the structured criteria part from the natural language text part and assigns them to distinct variables. The input of this step is the encoded network message; the server performs parsing and validation operations to produce as output a structured criteria set and a raw natural language string ready for further analysis.

### Step 4

The server performs natural language processing on the raw text. The server applies tokenization, part-of-speech tagging, and syntactic parsing to the natural language string using a language processing module. The server extracts important terms such as location names, numeric ranges, and feature descriptors, and then maps these terms to candidate criteria with associated confidence scores. For example, the server interprets “under 100,000 yen” as a candidate maximum rent and “in Shibuya” as a candidate area. The input of this step is the raw natural language text from Step 3; the server carries out linguistic analysis and semantic mapping operations to output a list of candidate criteria and their confidence values.

### Step 5

The server constructs a prompt sentence for a generative AI model. The server takes the candidate criteria and important terms from Step 4, together with predefined instructions, and assembles them into a prompt sentence that specifies the desired output fields. For example, the server may construct a prompt sentence such as: “From the following user request, extract area, maximum_rent, bath_toilet_separate (boolean), and minimum_floor (integer). The user request is: ‘Please search for rental properties in Shibuya with a monthly rent under 100,000 yen, a separate bath and toilet, and located on the second floor or higher.’ Return only the extracted values.” The input of this step is the set of candidate criteria and important terms; the server performs string concatenation and template filling operations to output a complete prompt sentence and an associated configuration for the generative AI model.

### Step 6

The server executes the generative AI model to obtain structured criterion information. The server feeds the prompt sentence and, optionally, the original user request into a trained neural network model, such as a transformer-based language model. The server encodes tokens into embeddings, propagates them through multiple attention and feed-forward layers, and decodes the result into text that follows the specified structure. The server may apply constrained decoding and post-processing to enforce that the output contains the required fields in a consistent format. The input of this step is the prompt sentence and model parameters; the server performs numerical matrix operations, attention-weight calculations, and decoding to produce as output structured criterion information, such as explicit field values for area, maximum rent, and other constraints.

### Step 7

The server integrates AI-derived criteria with user-entered structured criteria. The server takes the structured criterion information from Step 6 and the original structured fields received in Step 3 and performs a merge operation. The server applies conflict resolution rules, such as prioritizing explicit user fields or combining them using confidence scores, and may normalize units and categories. The input of this step is the structured criterion information and the original structured criteria; the server executes comparison, normalization, and rule-based selection to output finalized structured criterion information that includes consolidated constraints.

### Step 8

The server generates an optimized query sentence for the information storage apparatus. The server uses the finalized structured criterion information from Step 7 to select a query template and populate it with parameter values. The server orders conditions to align with existing indices in the storage schema and may include pagination parameters. The input of this step is the consolidated criterion set; the server performs template selection, parameter substitution, and query optimization heuristics to output a query sentence that is suitable for efficient indexed retrieval.

### Step 9

The server executes the optimized query on the information storage apparatus. The server sends the query sentence to a database engine or storage service, which parses the query and accesses index structures to locate matching records. The server receives a result set representing all records that satisfy the criteria. The input of this step is the optimized query sentence from Step 8; the database performs index lookups and record retrieval, and the server collects as output a set of data records, such as property entries with their associated attributes.

### Step 10

The server structures the retrieved data for display. The server partitions the result set into display units, computes an ordering based on relevance or user preferences, and selects which attributes to show at each detail level. The server constructs display-structured information, including page identifiers, item lists, and summary metadata. The input of this step is the raw result set from Step 9; the server applies sorting, grouping, and selection operations to output a display descriptor tailored for efficient rendering on the terminal.

### Step 11

The server analyzes user selection history and search history. For ongoing sessions, the server increments interaction logs based on which items have been selected, which queries have been executed, and how often criteria have been modified. The server periodically or on demand feeds this historical data into a learning module that updates internal models responsible for refining criteria and ranking results. The input of this step is the accumulated interaction data; the server uses statistical aggregation and machine learning algorithms to adjust model parameters and outputs updated refinement rules and ranking signals.

### Step 12

The server performs emotion analysis and adapts criteria and display configuration. The server uses features derived from the user's natural language content and interaction patterns to estimate an emotional state via a classification or regression model. The server adjusts threshold values, feature emphasis, and display density according to the inferred emotional state. The input of this step is current and historical user signals; the server computes affective scores and applies rule-based adaptations to output updated structured criterion information and modified display-structured information tuned to the user's state.

### Step 13

The server generates adaptive prompts to guide the user's next actions. The server combines the updated structured criterion information and the emotional state with predefined guidance strategies to form a new prompt sentence that suggests specific refinements or actions. For example, the server may generate text such as: “Would you like to narrow the search to properties within 10 minutes' walk from the station?” The input of this step is the updated criteria and emotional state from Steps 11 and 12; the server applies text template selection and optional generative AI processing to output a prompt sentence intended to induce a targeted user action.

### Step 14

The server transmits the display-structured information and adaptive prompts to the terminal. The server packages the display descriptor and the generated prompt text into a response message and sends it over the network interface. The input of this step is the final display-structured information and the adaptive prompt sentence; the server performs serialization and communication operations to output a response that the terminal can interpret and render.

### Step 15

The terminal renders the results and prompts for the user. The terminal receives the response from the server, parses the display-structured information, and constructs visual components such as lists, cards, and navigation elements. The terminal displays the items according to the specified ordering and pagination, and it also shows the adaptive prompt sentence near the search controls or results list. The input of this step is the response containing display-structured information and prompt text; the terminal executes layout calculations and drawing operations to output a visual arrangement on the display that the user can view and interact with.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information retrieval systems that rely on fixed graphical user interfaces and manual text input require users to translate complex, often ambiguous real-world intents into rigid keyword queries. Such systems generally process user input as a single, static request and fail to adapt in real time to evolving user preferences, emotional state, or multimodal interaction patterns (e.g., voice plus gesture). As a result, these systems exhibit several technical shortcomings: latency and friction in query formulation, inefficient utilization of input/output hardware, limited personalization of retrieval and ranking, and shallow integration of advanced machine learning components such as generative models and emotion analysis engines into the core retrieval loop.

In particular, systems that merely “layer” a generative AI model on top of existing search engines often treat the generative model as an external assistant that produces text descriptions, without structurally connecting model outputs to the underlying query construction, ranking logic, and user interface control. This loose coupling leads to non-deterministic behavior, unstable query generation, and difficulty in maintaining consistency between the user's true intent and the executed database operations. Furthermore, typical personalization mechanisms are based only on coarse search or click history, and do not exploit finer-grained interaction signals such as gaze, fixation, or detail-view operations available from head-mounted displays and other advanced visual devices.

Additionally, multimodal interfaces that accept voice and motion inputs tend to be implemented as independent modules, with voice recognition and gesture recognition operating in isolation and feeding into separate interaction flows. This fragmented architecture prevents efficient fusion of the inputs into coherent “criterion information,” limits the ability to continuously refine the query, and makes it difficult to apply machine learning and generative AI techniques in a unified manner. As a technical consequence, the overall computer system underutilizes sensor data, incurs redundant processing, and cannot fully optimize the retrieval and presentation pipeline.

There is therefore a need for a computer-implemented technique that (i) integrates voice recognition, motion recognition, natural language processing, generative AI models, machine learning-based preference profiling, and emotion analysis into a single, coordinated processing pipeline, (ii) transforms heterogeneous user signals into structured, machine-usable criterion information, (iii) uses generative models not only for natural language output but also for robust, schema-aware query generation and parameterization, and (iv) dynamically controls database retrieval, ranking, and real-time visual presentation on head-mounted displays. By addressing these technical issues, the computer system can improve the efficiency, accuracy, adaptability, and user relevance of information retrieval, thereby improving the functioning of the computer itself as an interactive information processing platform.

The specific processing by the specific processing unit 290 of the data processing device 12 in Application Example 1 is realized by the following means.

The present invention provides a server comprising a processor configured to receive, from a user device, voice information and motion information associated with a user, convert the voice information and the motion information into character information and command information by using voice recognition processing and motion recognition processing, acquire the character information and the command information as criterion information, analyze the criterion information by using natural language processing to extract keyword information including area information, price information, and condition information, convert the keyword information into structured criterion information for database search, generate a query sentence for acquiring target information stored in an information storage device on the basis of the structured criterion information, and search the target information by using the query sentence; to input at least the keyword information and the structured criterion information to a generative model and obtain, from the generative model, a prompt sentence including at least one of the query sentence for acquiring the target information, a normalization result of the criterion information, and supplementary condition information of the criterion information, and to use an output of the generative model to refine or validate the query sentence and to update the structured criterion information; to collect selection history information, search history information, and at least one of gaze information, fixation position information, and detail-display operation information of the user, analyze the collected information by using a machine learning algorithm to generate user profile information and weighting information by organizing and deepening the criterion information of the user, and assign priority to and reconfigure a retrieval result of the target information on the basis of the user profile information and the weighting information; to analyze an emotional state of the user by using emotion analysis processing, adjust at least one of the criterion information and the user profile information according to the emotional state, search related target information based on adjusted criterion information, and generate a prompt for urging the user to perform a specific action with respect to the related target information; and to convert the prioritized target information and the prompt into presentation information for a display device, transmit the presentation information to a visual device including a head-mounted display for real-time display, and acquire additional motion information from the visual device to generate control information for updating at least one of the criterion information and display content of the target information, and to perform re-search of the target information or acquisition of detailed information of the target information based on the control information. This enables tight, technical integration of multimodal input processing, generative model-based query and prompt generation, machine learning-based user profiling, emotion-adaptive adjustment, and real-time head-mounted visual presentation within a single server-controlled processing pipeline, thereby improving the efficiency, robustness, and adaptability of computer-implemented information retrieval and interaction.

The term “voice information” refers to audio data representing spoken utterances of a user, including continuous speech, discrete voice commands, and other vocal sounds captured by an input device such as a microphone.

The term “motion information” refers to data representing physical movements of a user or a device, including hand gestures, body movements, head movements, or controller operations detected by a sensor such as a camera, inertial sensor, or motion detector.

The term “character information” refers to symbolic information obtained by converting voice information into text, including words, phrases, sentences, and associated character codes suitable for natural language processing.

The term “command information” refers to control data derived from motion information or other inputs, which indicates an instruction or operation to be executed by a system, such as selection, scrolling, zooming, or confirmation.

The term “criterion information” refers to information representing one or more conditions, parameters, or preferences specified or implied by a user and used as a basis for searching, filtering, or ranking target information.

The term “natural language processing” refers to a computational technique for analyzing and processing human language expressions, including tokenization, morphological analysis, syntactic analysis, semantic analysis, entity extraction, and intent detection.

The term “keyword information” refers to one or more important terms or phrases extracted from criterion information, which represent core concepts such as location, price, category, or constraint and are used for query construction.

The term “area information” refers to keyword information representing a geographic region or location, including but not limited to a city, district, neighborhood, or other spatial designation.

The term “price information” refers to keyword information representing a monetary value or range, including but not limited to rent, sale price, budget limit, or price-related constraints.

The term “condition information” refers to keyword information representing non-price conditions or requirements, such as allowed usage, feature constraints, facility requirements, or other attribute-based restrictions.

The term “structured criterion information” refers to criterion information that has been transformed into a machine-readable structured format, such as key-value pairs, parameter objects, or database fields, suitable for use in query generation or algorithmic processing.

The term “database search” refers to a computational process of retrieving data from an information storage device by evaluating one or more conditions or parameters against stored records using a database management system.

The term “query sentence” refers to a machine-interpretable instruction for retrieving target information from an information storage device, including but not limited to a structured query language statement or a parameterized query representation.

The term “information storage device” refers to any hardware or software component capable of storing data, including memory devices, storage media, and database systems, such as relational databases, non-relational databases, or file storage systems.

The term “target information” refers to information that is to be retrieved, filtered, or presented in response to criterion information, including but not limited to records, documents, entries, or data objects stored in an information storage device.

The term “generative model” refers to a computational model configured to generate data, such as text, code, parameters, or structured information, based on an input prompt, and including but not limited to a generative AI model or a language model.

The term “prompt sentence” refers to an input sequence of text or symbols provided to a generative model in order to cause the generative model to generate an output, the input sequence including instructions, examples, or context information.

The term “normalization result” refers to information obtained by converting criterion information into a standardized or canonical representation, which reduces ambiguity and aligns the information with predefined formats or schemas.

The term “supplementary condition information” refers to condition information generated in addition to or as an extension of existing criterion information, which refines, narrows, or expands search conditions or parameters.

The term “selection history information” refers to data indicating which target information items a user has selected, confirmed, bookmarked, or otherwise interacted with in a selection-related manner.

The term “search history information” refers to data representing past searches performed by a user, including previous criterion information, query sentences, executed searches, and associated timestamps.

The term “gaze information” refers to data indicating a direction or target of a user's line of sight, including eye-tracking data or approximated viewing direction estimated from head orientation or other sensor outputs.

The term “fixation position information” refers to data indicating a position or region on a display or in a visual field where a user's gaze remains focused for a threshold period, suggesting attention or interest.

The term “detail-display operation information” refers to data indicating user operations that cause detailed information of target information to be displayed, including commands such as opening details, expanding an item, or zooming in on content.

The term “machine learning algorithm” refers to a computational algorithm that adjusts internal parameters or models based on data, in order to perform tasks such as classification, regression, clustering, or recommendation.

The term “user profile information” refers to structured information representing characteristics, preferences, or behavioral tendencies of a user, derived from history information and other interaction data.

The term “weighting information” refers to numerical or categorical values that indicate relative importance or priority of different attributes, criteria, or features when ranking or filtering target information.

The term “emotional state” refers to an estimated state of a user's emotions, such as satisfaction, frustration, interest, or boredom, derived from signals including voice, facial expressions, physiological data, or interaction patterns.

The term “emotion analysis processing” refers to computational processing for estimating the emotional state of a user based on one or more input signals, using techniques such as signal analysis, pattern recognition, or machine learning.

The term “related target information” refers to target information that is determined to be relevant or associated with adjusted criterion information, user profile information, or emotional state.

The term “prompt” refers to information presented to a user in order to encourage a response, decision, or action, including suggestions, recommendations, confirmations, or guidance messages.

The term “presentation information” refers to information that has been formatted or structured for display to a user, including layout, visual arrangement, annotations, and interactive elements.

The term “display device” refers to any hardware component capable of visually presenting information to a user, including flat-panel displays, projection devices, and wearable visual devices.

The term “visual device” refers to a display device configured to present information within a user's field of view, and may include a head-mounted display, smart glasses, or other wearable visual interface.

The term “head-mounted display” refers to a visual device worn on the head of a user, which presents images or information within the user's field of view, including optical see-through and video see-through configurations.

The term “control information” refers to data used to control operations of a system, including instructions to update criterion information, modify display content, trigger re-search operations, or request detailed target information.

The term “re-search” refers to performing a new or updated search process for target information based on modified criterion information, additional conditions, or updated control information.

The term “detailed information of the target information” refers to additional or more granular information associated with target information, such as extended attributes, metadata, images, documents, or related records.

In one embodiment, a server, a terminal, and a user cooperate to implement the claimed system. The server includes at least one processor, a volatile memory, a non-volatile storage device, a network interface, and an information storage device configured as a database system. The terminal includes at least one processor, a memory, a microphone, a camera, motion sensors such as an inertial measurement unit, and a visual device implemented as a head-mounted display. The user interacts with the terminal by voice and by physical movements, and views information through the head-mounted display.

The server executes application software implemented on a general-purpose operating system. The server uses a database management system such as a relational database engine, and uses libraries for natural language processing, machine learning, and generative AI model inference. For example, the server uses a natural language processing library to perform tokenization, part-of-speech tagging, named entity recognition, and dependency parsing, and uses a deep learning framework to execute a neural network-based generative AI model and a neural network-based emotion analysis model. The server stores target information in database tables having defined schemas, including fields for attribute values such as area, price, and condition. The server stores user profile information and history information in separate database tables with keys linked to user identifiers.

The terminal executes a client application implemented, for example, with a real-time graphics engine. The terminal controls the microphone to capture voice information, and controls the camera and motion sensors to capture motion information. The terminal performs pre-processing, such as noise reduction and sampling of the audio signal, and passes the audio signal to a voice recognition module. The voice recognition module may be executed locally on the terminal or as a cloud-based service accessed by the terminal via the network interface. In one example, the terminal accesses a cloud speech recognition API that uses a deep neural network-based acoustic model and a language model to convert the audio signal into character information. The terminal receives transcribed text from the speech recognition module and sends the text to the server as part of the criterion information.

The terminal also performs motion recognition processing. The terminal uses the camera to capture a sequence of image frames representing the user's hand gestures or body movements. The terminal uses a computer vision library, such as one implementing convolutional neural network-based hand pose estimation, to detect key points of the user's hand and determine gesture types such as swipe, pinch, or point. The terminal converts the detected gesture types into command information. In another implementation, the terminal uses the inertial measurement unit to detect head movements and combine them with gaze estimation to identify fixation position information. The terminal transmits the command information, gaze information, and fixation position information to the server via the network interface.

The server acquires the character information and the command information as criterion information. The server uses a natural language processing module implemented with a library such as an open-source tokenizer, parser, and named entity recognizer to analyze the character information. The server identifies entities such as geographic areas, price ranges, and condition terms. The server uses a rule-based mapping layer to map token sequences into attribute identifiers, for example, mapping “under 100,000 yen” to a numeric constraint, and mapping “pets allowed” to a boolean attribute. The server thus generates structured criterion information in the form of key-value pairs, such as (area: “Shinjuku”), (max_price: 100000), (pets_allowed: true). The server stores the structured criterion information in a memory structure and further into a criterion information table of the database.

The server then generates a query sentence for retrieving target information from the information storage device. The server uses a query construction module that maps the structured criterion information to a structured query language statement. The query construction module uses a schema registry that stores definitions of table names, column names, and data types. The module converts (area: “Shinjuku”) to a condition on an area column, converts (max_price: 100000) to a condition on a price column, and so forth. The module concatenates these conditions with logical operators and generates a query sentence that is syntactically valid for the underlying database engine.

In order to improve robustness and flexibility of query generation, the server uses a generative AI model as an auxiliary component. The server executes a generative AI model, for example, a transformer-based language model with multiple self-attention layers. The generative AI model has been trained in advance using supervised and unsupervised learning on text data representing queries, criteria, and schema descriptions. During inference, the server passes a prompt sentence to the generative AI model. For example, the server uses a prompt sentence such as: “Generate an SQL query that retrieves rental properties in the Shinjuku area with a monthly rent less than or equal to 100000 yen and where pets are allowed, using the table name ‘properties’ and columns ‘area’, ‘monthly_rent’, and ‘pets_allowed’.”

The server also may use a prompt sentence such as: “Normalize the following real-estate criteria: ‘Find apartments in the Shinjuku area under 100,000 yen that allow pets’ and output the normalized criteria text.”

The server inputs such prompt sentences, together with structured criterion information and schema information, to the generative AI model. The generative AI model computes self-attention over token embeddings and produces token sequences representing proposed query sentences or normalized criterion information. The server receives the proposed query sentence and applies a validation module that parses the proposed query, checks for consistency with the schema registry, and rejects tokens that refer to non-existent tables or columns. The validation module thus enforces a non-conventional rule-based filter on the output of the generative model, reducing errors and improving technical reliability in comparison with a human-only or naive generative approach.

The server further collects selection history information, search history information, and interaction-related information such as gaze information, fixation position information, and detail-display operation information from the terminal. The terminal, for example, transmits events when the user stares at a particular item for a threshold duration or when the user performs a detail-open command via gesture. The server logs each event with time stamps, identifiers of target information, and context such as current criterion information. The server stores this data in a user behavior table.

The server executes a machine learning algorithm to derive user profile information and weighting information from the user behavior table. For example, the server uses a neural network model with an embedding layer for categorical attributes, a recurrent or transformer layer for temporal sequences, and a dense output layer producing a preference vector. The server feeds the user's historical sequences of interactions into this model and obtains a vector that encodes relative preferences for attributes such as price, area type, building age, and proximity to transportation. The server uses this vector as user profile information and also interprets the normalized components of the vector as weighting information. The server caches this information in a user profile table and in memory.

When the server receives a retrieval result set from the database, the server applies a ranking module that reorders the result set based on the weighting information. The ranking module computes a score for each candidate item by a weighted sum of attribute features, such as normalized price, distance, and building age, using the weighting information as coefficients. The module may also use a gradient-boosted decision tree model trained on relevance labels to refine ranking. This technical process improves ranking precision and reduces the time the user needs to find relevant items, thereby improving system efficiency.

The server also executes an emotion analysis module that estimates an emotional state of the user. The server receives signals such as prosodic features from voice information, timing of interactions, and potentially facial expressions gleaned from video frames. The server extracts features such as pitch, energy, speaking rate, and temporal interaction patterns, and feeds these features to a neural network classifier trained to output emotion labels or continuous scores, such as valence and arousal. The server obtains an estimated emotional state and updates an emotion state table associated with the user.

The server uses the emotional state to adjust criterion information or user profile information. For example, if the emotion analysis indicates frustration, the server relaxes certain strict criteria by modifying constraints in the structured criterion information. If the emotional state indicates satisfaction when certain types of items are selected, the server increases weights for corresponding attributes. The server may generate a prompt for the user, for example:

“You seem to prefer newer apartments near the station. Would you like to filter to buildings built within the last 10 years?”

This prompt is generated by the server using either rule-based templates or a generative AI model with a prompt sentence such as:

“Given the following user profile and search history, generate a short suggestion to refine the user's apartment search in a polite and concise manner.”

By explicitly using measured emotion and learned preferences, the server dynamically adapts the data processing pipeline and improves interaction robustness and user relevance.

The server converts the prioritized target information and the generated prompt into presentation information. The server formats the presentation information as structured data for the client application, including coordinates for placing items in a virtual space, font and color attributes, and interaction hotspots. The terminal receives the presentation information and uses its graphics engine to render panels, lists, or spatially arranged cards in the head-mounted display. The terminal updates the presentation in real time, which requires the server to send incremental updates constrained in size to reduce communication load. By sending only changed items or compressed differential representations, the server reduces bandwidth usage and latency, which is a technical improvement in communication efficiency.

The terminal continuously captures additional motion information from the user, including hand gestures and head movements. The terminal identifies control gestures, such as a pinch to open details or a swipe to change pages, and sends corresponding control events to the server. The server interprets these control events as operations on the underlying data, such as narrowing filters, requesting detail views, or triggering re-search. The server then performs the requested operation on the database, updates the ranking using the updated profile and criterion information, and sends new presentation information to the terminal. This closed-loop control between user motions, server processing, and visual output improves responsiveness and makes the head-mounted device an active part of the computation, not a passive display.

In another embodiment, the server executes the voice recognition processing locally rather than relying on an external service. The server loads an acoustic model and a language model trained on domain-specific data, such as common phrases in real estate or other domains. This local processing reduces round-trip latency and protects privacy. The server may implement a streaming decoder that incrementally updates character information as the user speaks, enabling near real-time criterion updates and dynamic adjustments of presentation information. This architecture improves processing speed and user experience beyond what manual entry or simple batch speech-to-text could provide.

In yet another embodiment, the generative AI model is implemented as a transformer-based neural network with multiple encoder and decoder layers, each layer including multi-head self-attention and feed-forward sub-layers. The server trains the model on paired data of natural language criteria and structured queries. The server uses a loss function that includes a cross-entropy term for token prediction and a penalty term when proposed tokens refer to non-existent schema elements. The server updates model weights using gradient-based optimization, such as stochastic gradient descent or adaptive moment estimation. The server may also apply data augmentation by synthesizing additional training examples through paraphrasing or schema permutations. This non-standard training procedure explicitly encodes schema constraints into the generative model, further lowering the error rate of generated queries and improving technical performance over naive language modeling.

In yet another embodiment, the server applies non-conventional rules to combine outputs of the generative AI model with rule-based components. For example, the server first lets the generative AI model propose a set of candidate conditions, then applies a conflict resolution algorithm that prefers conditions consistent with historical user behavior or profile information. The server calculates a consistency score between candidate conditions and the user profile vector, discards low-scoring conditions, and optionally requests a revised proposal from the generative model with a modified prompt sentence that includes feedback, such as:

“The user tends to choose properties under 80000 yen. Adjust the following criteria to better match this preference.”

This iterative, feedback-based integration of generative AI output and learned user profiles constitutes a technical mechanism not present in conventional manually constructed queries, increasing both accuracy and stability while reducing the computational burden on the user.

The described embodiments focus on the technical cooperation between server, terminal, and user, emphasizing data structures, model architectures, and algorithmic flows. The system does not merely automate human decision-making; instead, the system reconfigures internal computer processes, such as query construction, ranking computation, model-based adaptation, and communication scheduling, in ways that are specifically tailored to the technical capabilities of multimodal sensors and head-mounted displays. As a consequence, the system achieves improved processing speed through streaming recognition and incremental ranking updates, improves accuracy through schema-aware generative query generation and machine-learned preference weighting, and reduces error rates in query execution through rule-based validation and constraint-aware training of models. These improvements manifest as measurable reductions in processing latency, improved click-through relevance metrics, reduced network load per interaction, and increased robustness to noisy or ambiguous inputs.

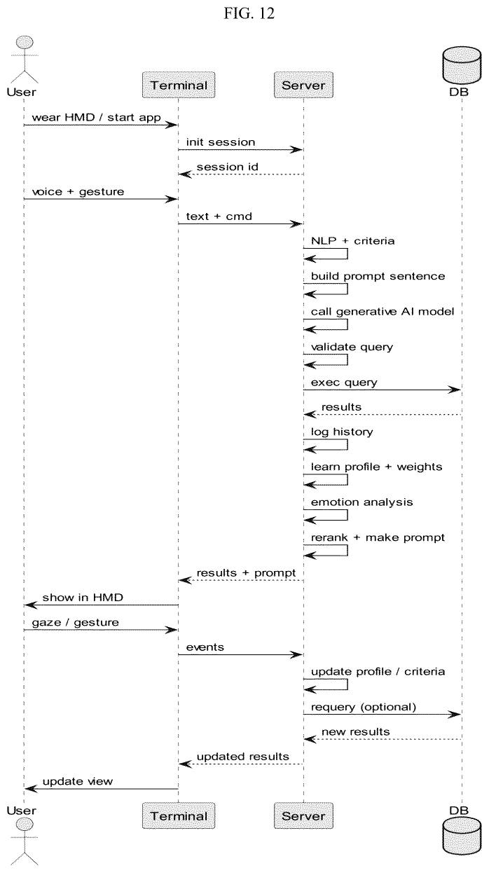

The following describes the processing flow using FIG. 12.

### Step 1

User wears the terminal in the form of a head-mounted display and activates an application for information retrieval.

Terminal initializes a microphone, a camera, motion sensors, a graphics engine, and a network interface, and displays a standby screen in the head-mounted display.

Input: no user criteria yet; only system configuration parameters.

Terminal allocates buffers for audio samples and image frames, initializes sensor drivers, and establishes a network connection to the server.

Output: an active session request containing device identifiers and initialization data is transmitted from the terminal to the server.

### Step 2

Server receives the session request from the terminal and creates a new session record in an information storage device.

Input: session request including device identifiers, timestamp, and application type.

Server performs a data insertion operation into a session table and generates a session ID, and stores default criterion information and profile placeholders linked to that session ID.

Output: a session acknowledgment including the session ID and configuration parameters is transmitted from the server to the terminal.

### Step 3

User speaks a natural-language instruction into the microphone of the terminal, such as “Find apartments in the Shinjuku area under 100,000 yen that allow pets.”

Terminal captures continuous audio samples from the microphone, performs noise reduction and framing, and sends the audio stream to a voice recognition module.

Input: raw audio waveform from the user's speech.

Terminal converts the waveform into a sequence of feature vectors (for example, Mel-frequency cepstral coefficients), packages these features into requests, and transmits them to a speech-to-text engine.

Output: character information representing the spoken sentence is returned from the speech-to-text engine to the terminal and then sent to the server.

### Step 4

User performs a gesture, such as pointing at a region of the display or performing a pinch gesture, to indicate an operation like “start search” or “show filters.”

Terminal captures image frames from the camera and motion readings from motion sensors, and applies motion recognition processing.

Input: image frames containing the user's hands and body, and motion sensor readings containing acceleration and rotation.

Terminal uses a gesture recognition model to detect keypoints of the hand and infer a gesture label, and combines this label with temporal thresholds to distinguish intentional commands from random motion.

Output: command information representing the gesture type and associated parameters is generated and sent to the server as part of criterion information.

### Step 5

Server receives character information and command information from the terminal and acquires them as criterion information.

Input: transcribed text of the user's speech and gesture-based command labels with parameters.

Server concatenates or associates the text and command labels, and stores them in a criterion buffer, tagging each piece of data with the current session ID and timestamps.

Output: a combined criterion object representing both textual criteria and operation commands is produced and passed to a natural language processing module.

### Step 6:

Server analyzes the character information using natural language processing to extract keyword information such as area, price, and conditions.

Input: criterion object containing raw text.

Server uses tokenization, part-of-speech tagging, and entity recognition to split the text into tokens, identify numeric phrases, and detect domain-specific terms. The server then applies a rule-based mapping to convert recognized phrases such as “Shinjuku area” into area identifiers and “under 100,000 yen” into a numeric upper bound.

Output: keyword information including area information, price information, and condition information is generated in intermediate data structures.

### Step 7

Server converts the keyword information into structured criterion information that can be used for database search.

Input: extracted keyword information in unstructured or semi-structured form.

Server applies mapping rules to associate keywords with database fields and types, normalizes numeric values to a standard currency and unit, and encodes categorical terms into canonical labels.

Output: structured criterion information, represented as key-value pairs or parameter objects, is stored in memory and optionally written to a criterion information table linked to the session.

### Step 8

Server generates a query sentence for retrieving target information from an information storage device on the basis of the structured criterion information.

Input: structured criterion information and schema information describing table names and column names.

Server executes a query construction algorithm that transforms each key-value pair into a condition clause, combines clauses with logical operators, and builds a syntactically correct query sentence for a database engine.

Output: a query sentence, such as a structured query language statement with parameter placeholders, is produced and passed to a query execution module.

### Step 9

Server uses a generative AI model to refine or assist the query generation and criterion normalization.

Input: structured criterion information, schema information, and optionally a draft query sentence.

Server constructs a prompt sentence, for example “Generate an SQL query that retrieves rental properties in the Shinjuku area with a monthly rent less than or equal to 100000 yen and where pets are allowed, using the table name ‘properties’ and columns ‘area’, ‘monthly_rent’, and ‘pets_allowed’.” and inputs the prompt sentence into the generative AI model.

Server receives a proposed query sentence or a normalized criterion description from the generative AI model, compares it with the draft query using a parser, and resolves inconsistencies using schema validation and rule-based filters.

Output: a validated, schema-consistent query sentence and optionally refined structured criterion information are produced and stored in memory.

### Step 10

Server executes the validated query sentence against the information storage device and retrieves target information.

Input: validated query sentence and database connection parameters.

Server sends the query sentence to a database management system, which performs internal operations such as index scanning, condition evaluation, and row retrieval. The server then receives records matching the criteria and converts them into an internal result set.

Output: target information in the form of structured records representing items such as properties, including fields like identifiers, area, price, and additional attributes.

### Step 11

Server logs search history information representing the executed query and its parameters.

Input: structured criterion information, query sentence, and metadata such as timestamp and session ID.

Server performs a write operation to a search history table, storing the query text, structured parameters, and a link to the session and user identifiers.

Output: an updated search history data set is accumulated in the information storage device for future learning and analysis.

### Step 12

Server transmits the retrieved target information to the terminal as prioritized or raw results and prepares for later ranking refinement.

Input: target information records from the database.

Server formats the records into a response message, compresses the payload if necessary, and attaches layout hints such as grouping or ordering instructions.

Output: a response message containing target information is sent over the network to the terminal.

### Step 13

Terminal receives the target information and generates presentation information suitable for display in the head-mounted display.

Input: response message with target information and layout hints.

Terminal parses the message, constructs visual elements such as cards, lists, or spatial panels, and computes 3D positions and orientations for rendering them in the virtual space.

Output: a scene graph or rendering command set is produced and fed into the graphics engine.

### Step 14

Terminal displays the presentation information to the user via the head-mounted display.

Input: rendering command set representing positions and visual attributes of items.

Terminal executes rendering operations using its graphics pipeline, draws the target information as text, images, and icons in the user's field of view, and overlays interaction indicators for gaze selection or gesture-based selection.

Output: visual output in the head-mounted display, enabling the user to observe multiple target information items and prompts.

### Step 15

User visually examines the displayed target information and focuses gaze or performs gestures to interact with specific items.

Input: visual output from the terminal.

User directs attention to a particular item or performs a gesture such as a pinch to open details or a swipe to move between pages.

Output: gaze information and new motion information are produced and captured by the terminal.

### Step 16

Terminal measures gaze information and fixation position information based on sensor data and forwards this information to the server.

Input: eye-tracking sensor readings or head orientation and dwell time data.

Terminal computes the intersection of the user's gaze direction with virtual objects, determines which item is being fixated for more than a threshold period, and encodes this as fixation position information.

Output: gaze information and fixation position information linked to specific target information items are transmitted to the server.

### Step 17

Server collects selection history information, gaze information, fixation position information, and detail-display operation information as user behavior data.

Input: interaction event messages from the terminal referencing item identifiers and event types.

Server appends each event to a user behavior table, storing attributes such as item identifier, event type, timestamp, and context, using database insert operations.

Output: an enriched user behavior history associated with the user and session is stored for subsequent analysis.

### Step 18

Server executes a machine learning algorithm to derive user profile information and weighting information from the collected user behavior data.

Input: user behavior history data and existing user profile vectors, if any.

Server extracts features representing counts, frequencies, and co-occurrences of attribute values from the behavior history, feeds these features into a trained neural network or other machine learning model, and computes an updated preference vector.

Output: user profile information encoding preferences and weighting information representing attribute importance are produced and stored in a user profile table.

### Step 19

Server reorders the target information using the weighting information to produce a prioritized result set.

Input: target information records and weighting information.

Server computes a relevance score for each record by applying a scoring function that multiplies normalized attribute values by corresponding weights and summing the results, or by passing feature vectors into a ranking model.

Output: a reordered list of target information items, sorted by computed relevance score, is generated and used for updated presentation.

### Step 20

Server executes emotion analysis processing on signals associated with the user to estimate an emotional state.

Input: prosodic features from voice recordings, interaction timing patterns, and optionally image-based facial expression features.

Server extracts numerical features such as pitch variance, energy profiles, and interaction delays, and inputs them into a trained emotion classification model to produce an estimated emotional state label or continuous scores.

Output: emotional state data associated with the user and the current session is generated and stored in an emotion state table.

### Step 21

Server adjusts criterion information or user profile information based on the estimated emotional state.

Input: structured criterion information, user profile information, and emotional state.

Server applies adjustment rules, such as relaxing strict filters when frustration is detected or tightening preferred constraints when satisfaction is observed, and modifies numeric thresholds or attribute weights accordingly.

Output: adjusted criterion information and updated user profile information are produced and stored in memory for subsequent searches.

### Step 22

Server generates prompts to suggest specific actions or additional conditions to the user based on the adjusted profile and emotional state.

Input: adjusted criterion information, user profile information, emotional state, and rule templates or generative model capabilities.

Server may construct a prompt sentence using templates or call a generative AI model with a prompt sentence such as “Given this user profile and search history, suggest three additional filtering criteria that would help this user find an ideal rental in central Tokyo.”

Output: prompt text encouraging the user to refine filters or take a particular action is generated and sent to the terminal as part of presentation information.

### Step 23

Terminal displays the generated prompt together with prioritized target information in the head-mounted display.

Input: prompt text and reordered target information from the server.

Terminal updates visible elements to include a text or icon-based suggestion panel and repositions or reorders items according to the new prioritization, executing rendering updates.

Output: updated visual presentation enabling the user to read suggestions and interact with newly prioritized items.

### Step 24:

User responds to the prompt by voice or gesture, for example by saying “Yes, filter to newer than 10 years” or performing a gesture indicating acceptance.

Input: visual prompt and displayed filters.

User issues an explicit confirmation or modifies the search criteria via multimodal interactions.

Output: new voice information and motion information encoding the user's response are produced and captured by the terminal, which then transmits updated character information and command information to the server, thereby initiating a new iteration of the processing flow.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval systems and recommendation systems typically treat user-specified criteria and simple behavioral logs as static filters or coarse signals. In many cases, these systems apply manually designed rules or generic ranking models that do not fully exploit the rich structure of user interaction histories, such as selection history and search history. As a result, such systems often fail to uncover latent criteria that significantly influence user choices but are not explicitly expressed as search conditions. Consequently, the systems may return results that appear relevant in terms of explicit filters but do not align with the user's true underlying preferences, leading to reduced user satisfaction and inefficient use of computational resources devoted to retrieval and ranking.

Additionally, existing systems that integrate natural language interfaces or generative models typically use a generative model only to produce user-facing text, such as summaries or generic suggestions, without systematically binding the generative model's outputs to structured preference representations that can be re-used by the search engine. These approaches generally do not define a technical pipeline in which behavioral data are preprocessed into machine-learning-ready formats, analyzed to extract preference patterns, converted into human-readable explanations, and then fed as structured prompt sentences to a generative model to obtain actionable, machine-interpretable criteria. This lack of an integrated pipeline limits the ability of computing systems to adaptively refine search conditions in a robust and repeatable way, and constrains the technical performance of the overall retrieval process.

Moreover, many prior systems do not explicitly combine emotion analysis of user input or behavior with generative modeling in order to adjust preference criteria and guidance. In such systems, emotional context is either ignored or treated as a superficial label, and is not systematically embedded into prompts or downstream preference updates. As a result, the system cannot technically adjust its retrieval behavior and user guidance in a manner that is sensitive to emotional signals, which may be critical for appropriate timing and framing of recommended actions.

In view of the foregoing, there is a need for an improved computer-implemented technique that (i) transforms raw user histories into normalized, machine-learning-ready data structures; (ii) extracts explicit and latent criteria by using machine learning; (iii) converts these criteria into structured, human-readable explanations; and (iv) uses these explanations as part of prompt sentences to a generative artificial intelligence model to obtain candidate criteria and guidance that can be re-incorporated into the system as structured search conditions. There is also a need for a system that incorporates emotion analysis results into such prompt sentences, so that latent criteria and guidance information are computationally adjusted in response to the emotional state of the user. By addressing these needs at the level of concrete data processing, model interaction, and control flow within the server, the invention aims to improve the functioning of the computer system itself in terms of accuracy, adaptability, and the quality of search results and guidance produced under constrained computational resources.

The specific processing by the specific processing unit 290 of the data processing device 12 in Example 2 is realized by the following means.

The present invention provides a server comprising a processor and a storage resource, the processor being configured to execute instructions that cause the server to receive, via an input/output interface, input information expressed in natural language from a user, to analyze the input information by using a natural language processing technique to extract one or more important terms representing requests of the user, to construct, on the basis of the one or more important terms, a query sentence to be input to a generative artificial intelligence model, and to supply the query sentence to the generative artificial intelligence model so as to generate a prompt sentence for identifying one or more related information resources or one or more related functions; to acquire, from the storage resource, selection history information and search history information associated with the user, and to perform preprocessing on the selection history information and the search history information, the preprocessing including data processing of removing duplicate information, complementing missing information, and normalizing numerical information, thereby generating a history data set in a format suitable for machine learning processing; to analyze the history data set by using a machine learning algorithm to extract a group of criteria representing consistent preference tendencies of the user in selection of information resources, and to estimate, on the basis of the extracted group of criteria, one or more latent criteria that are not explicitly designated by the user; to convert the preference tendencies and the latent criteria into explanatory information in a human-readable format, and to construct, by using the explanatory information, a prompt sentence for the generative artificial intelligence model so as to obtain, from the generative artificial intelligence model, response information including one or more candidate criteria to be presented to the user and reasons corresponding to the one or more candidate criteria; to construct, on the basis of the response information, a candidate list including the latent criteria, to accept a selection operation of the user with respect to one or more candidate criteria included in the candidate list, and to register the selected one or more candidate criteria as search conditions of the user in the storage resource; to search, on the basis of the registered search conditions, an information resource set stored in the storage resource to generate a search result that reflects explicit criteria and latent criteria of the user, and to present the search result to the user via the input/output interface; and to generate, by using the generative artificial intelligence model, guidance information for prompting the user to perform a specific action related to the search result, and to present the guidance information to the user via the input/output interface. This enables the computer system to technically improve the retrieval and recommendation process by transforming raw behavioral and natural-language data into normalized machine-learning-ready structures, by extracting and structuring explicit and latent criteria, by leveraging generative artificial intelligence through carefully constructed prompt sentences to obtain machine-interpretable candidate criteria and guidance, and by feeding back selected criteria and emotion-aware adjustments into the search and guidance loop, thereby enhancing the accuracy, adaptability, and relevance of search results and user prompts while improving the overall functioning of the server-implemented information processing system.

The term “processor” refers to a hardware or virtualized computation unit that executes instructions to perform arithmetic, logic, control, and input/output operations in order to implement the functions of the system.

The term “storage resource” refers to any non-transitory computer-readable medium or combination of media configured to store data, programs, models, and intermediate results, including but not limited to magnetic storage, optical storage, and semiconductor memory.

The term “input/output interface” refers to a hardware and/or software interface that enables exchange of information between the system and external entities, such as users, terminals, or other servers, through communication channels including networks, displays, keyboards, touchscreens, and communication adapters.

The term “user” refers to any human individual or organizational entity that interacts with the system by providing input information and receiving output information.

The term “input information expressed in natural language” refers to information provided by the user in a human language, such as text or speech converted to text, including queries, requests, feedback, or other utterances.

The term “natural language processing technique” refers to a computational method or algorithm for analyzing natural language text, including operations such as tokenization, part-of-speech tagging, syntactic analysis, semantic analysis, and key phrase extraction.

The term “important terms” refers to words, phrases, or expressions extracted from the input information that are determined, by the natural language processing technique, to be significant for representing the user's requests, constraints, or intentions.

The term “query sentence” refers to a structured textual sequence constructed on the basis of the important terms and intended to be supplied as input to a generative artificial intelligence model in order to obtain a response.

The term “generative artificial intelligence model” refers to a machine-implemented model configured to generate output data, including natural language text, in response to input data, and comprising, for example, a probabilistic model, a neural network, or a transformer-based language model.

The term “prompt sentence” refers to a natural language text provided as input to the generative artificial intelligence model, the prompt sentence specifying instructions, context, or constraints that guide the generation of the model's output.

The term “information resource” refers to any digital content or data object retrievable by the system, including records, documents, media items, or database entries relevant to a user's request.

The term “function” refers to a capability of the system or an associated application, including but not limited to search, recommendation, filtering, summarization, or action invocation.

The term “selection history information” refers to stored data representing past selection-related actions of the user with respect to information resources, including views, clicks, bookmarks, purchases, or inquiries.

The term “search history information” refers to stored data representing past search-related actions of the user, including search queries, filter settings, sorting preferences, and timestamps.

The term “preprocessing” refers to a set of data manipulation operations performed to transform raw selection history information and search history information into a structured, consistent, and machine-learning-ready form.

The term “duplicate information” refers to multiple records that represent the same user action or event within a defined equivalence rule, such as identical user identifiers, resource identifiers, and timestamps.

The term “complementing missing information” refers to a process of filling or imputing absent values in data records, using techniques such as substitution with default values, statistical values, or inferred values.

The term “normalizing numerical information” refers to transforming numerical data into a scaled or standardized form, such as rescaling within a predetermined range or standardizing based on mean and variance, to facilitate machine learning processing.

The term “history data set” refers to a structured collection of preprocessed data derived from selection history information and search history information, formatted for input to a machine learning algorithm.

The term “machine learning algorithm” refers to a computational procedure that learns patterns or models from data, including but not limited to clustering, classification, regression, or ranking algorithms implemented in software.

The term “group of criteria” refers to a set of conditions, attributes, or feature patterns that collectively describe consistent user preferences in relation to information resource selection.

The term “preference tendencies” refers to statistically or algorithmically inferred inclinations of the user to favor certain attributes, conditions, or combinations thereof when selecting information resources.

The term “latent criteria” refers to criteria that influence the user's preferences but are not explicitly specified by the user as search conditions and are inferred by analysis of the history data set.

The term “explanatory information” refers to human-readable descriptions that explain or summarize the preference tendencies and latent criteria in natural language.

The term “response information” refers to output data generated by the generative artificial intelligence model in response to a prompt sentence, including proposed criteria, explanations, and other relevant content.

The term “candidate criteria” refers to criteria proposed by the system, including inferred latent criteria and associated explanations, which may be accepted or rejected by the user for use as search conditions.

The term “candidate list” refers to a set of candidate criteria organized in a structured form for presentation to the user and for subsequent selection processing.

The term “selection operation” refers to an input action by which the user indicates acceptance, rejection, or modification of one or more candidate criteria, performed via the input/output interface.

The term “search conditions” refers to a set of constraints, filters, or preferences used by the system to retrieve or rank information resources in response to a user's request.

The term “information resource set” refers to a collection of information resources stored in the storage resource and subject to search or filtering based on search conditions.

The term “search result” refers to output data representing one or more information resources retrieved in accordance with the search conditions, optionally including ranking scores and associated metadata.

The term “guidance information” refers to natural language or structured content generated for the purpose of prompting or recommending that the user perform a specific action related to a search result, such as viewing, saving, purchasing, or inquiring.

In one embodiment, a server implements the claimed system by executing a program stored in a non-transitory computer-readable medium. The server includes a processor, a main memory, a network interface, and a storage resource such as a hard disk drive or solid-state drive. The storage resource stores user history data, trained machine learning models, configuration data, and executable instructions. The server communicates with at least one terminal operated by a user through a communication network.

The terminal is, for example, a smartphone, a tablet device, or a personal computer. The terminal includes an input/output interface such as a touchscreen, a keyboard, and a display. The terminal presents user interfaces for inputting natural language queries and for displaying search results and guidance information received from the server. The user operates the terminal to enter free-form natural language utterances and to select or modify criteria suggested by the server.

The server executes an application program built on a server-side framework such as a web application framework (for example, a general web framework configured to process HTTP requests). The server uses a relational database management system such as a generic SQL database to store selection history information and search history information. The server uses a data processing library such as a column-oriented data frame library or a distributed data processing engine to perform preprocessing, and uses a machine learning framework such as a neural network computation framework to implement preference analysis models. The server accesses a generative AI model through an API endpoint, where the generative AI model is implemented as a transformer-based language model deployed on a separate inference server.

The server receives input information expressed in natural language from the user via the terminal. The input information includes, for example, a text such as “I am looking for an apartment near the station with good sunlight and a reasonable rent.” The server performs tokenization, part-of-speech tagging, dependency parsing, and named-entity recognition on the input information using a natural language processing module implemented in software. The server identifies important terms such as “apartment,” “near the station,” “good sunlight,” and “reasonable rent” as important terms representing requests of the user.

The server constructs a query sentence to be input to the generative AI model. In one embodiment, the server arranges the important terms in a structured template that explicitly instructs the generative AI model how to interpret the user's request. For example, the server constructs a query sentence such as: “Extract the main constraints and preferences from the following user query: ‘I am looking for an apartment near the station with good sunlight and a reasonable rent.’ Identify key criteria and their relative importance.”

The server supplies this query sentence to the generative AI model as a prompt sentence. The generative AI model is, for example, a transformer-based model having multiple attention layers, feed-forward layers, and layer normalization components. The generative AI model receives the prompt sentence and generates an output text that enumerates criteria and their importance. The server receives this output and stores it in the storage resource.

The server acquires selection history information and search history information associated with the user from the database. The selection history information includes, for example, records of properties viewed, bookmarked, or inquired about by the user, each record containing a user identifier, a resource identifier, timestamps, and associated resource attributes. The search history information includes, for example, records of past search queries, including search keywords, filter values, and sorting options. The server loads these records into a data frame structure in memory.

The server performs preprocessing on the selection history information and the search history information. The server removes duplicate records by applying an equivalence rule on user identifier, resource identifier, and timestamp. The server detects missing values in attributes such as price, area, construction year, or distance from a reference point, and complements missing values using statistical imputation, such as replacing with a median value computed per region. The server normalizes numerical attributes such as price, area, and distance using standardization so that each attribute has a mean of zero and a unit variance. This normalization improves the convergence behavior and stability of downstream machine learning algorithms. The server encodes categorical attributes, such as property type, layout type, and pet-allowed flag, using one-hot encoding or embedding indices, forming a numerical feature vector for each history record. By applying these specific transformations, the server converts irregular, noisy log data into a history data set with a fixed schema and consistent numerical scale, which improves model accuracy and reduces training time.

The server analyzes the preprocessed history data set by using a machine learning algorithm. In one embodiment, the server uses a neural network model implemented in a neural network framework. The neural network model comprises an input layer receiving the feature vector, several hidden layers with rectified linear unit activation functions, and an output layer that predicts a probability that the user will perform a target action, such as bookmarking or inquiring about a resource. The server trains this neural network offline using historical data of multiple users, applying a supervised learning method with a cross-entropy loss function. During training, the server updates model weights using a gradient-based optimizer such as stochastic gradient descent or Adam. The server may use data augmentation techniques such as random dropout on hidden units to prevent overfitting and to improve generalization.

In another embodiment, the server uses an unsupervised learning algorithm such as clustering. The server generates low-dimensional embeddings of user-resource interactions by training an autoencoder or a matrix factorization model. The server then applies a clustering algorithm such as k-means clustering to these embeddings in order to group similar behavior patterns. Cluster centroids represent prototypical preference profiles.

During operation, the server applies the trained model to the history data set of the user. The server computes, for each resource attribute, a contribution score indicating how strongly that attribute correlates with positive user actions. The server can compute feature importance values by perturbing feature values and measuring changes in predicted probabilities, or by analyzing learned weights of the model. The server aggregates these contributions across many interactions to obtain stable preference tendencies, such as a high weight on “distance to station≤10 minutes,” a high weight on “construction year within last 5 years,” and a medium weight on “pet-allowed flag is true.” These aggregated patterns form a group of criteria representing consistent preference tendencies of the user.

The server estimates latent criteria by comparing explicit filters specified by the user with the extracted group of criteria. For example, if the user rarely sets a “pet-allowed” filter but the model indicates a significant positive correlation between pet-allowed properties and user bookmarks, the server infers a latent criterion “pet-friendly properties.” The server also infers compound criteria, such as “quiet residential area,” by recognizing combinations of features that frequently co-occur in positively evaluated records (for example, small street frontage, low traffic noise, and residential zoning).

The server converts the group of criteria and the latent criteria into explanatory information in human-readable format. For example, the server generates descriptions such as “You frequently choose properties within a 10-minute walk from a station” or “You often view pet-friendly properties even when you do not explicitly filter by pet-allowed.” The server then constructs a prompt sentence for the generative AI model that includes these explanations. For example, the server may construct the following prompt sentence:

“The user has the following selection history and search history:
Often views properties within 10 minutes' walk from a station.
Frequently clicks and bookmarks newer properties (built within the last 5 years).
Sometimes opens pet-friendly properties, even when ‘pet allowed’ is not selected as a filter.

Based on these behaviors, analyze the criteria that the user values in choosing properties. Then, identify additional criteria that the user may care about but has not explicitly set as conditions. Return the result as a list of criteria with short explanations.”

The server supplies this prompt sentence to the generative AI model. The generative AI model uses its transformer architecture to attend to different parts of the prompt, to model dependencies among criteria and behaviors, and to generate an output list of candidate criteria and explanations. The server receives response information including candidate criteria and reasons corresponding to the candidate criteria.

The server parses the response information to construct a candidate list containing candidate criteria such as “pet-friendly properties,” “quiet residential area,” and “good sunlight.” Each candidate criterion is represented as a structured record including an internal identifier, a human-readable label, and an explanation text. The server stores this candidate list in the storage resource. The terminal receives the candidate list and displays each candidate criterion as an option in the user interface, such as toggle switches or checkboxes with explanatory text.

The user operates the terminal to perform a selection operation, accepting or rejecting one or more candidate criteria. For example, the user may enable “pet-friendly properties” and “built within the last 5 years,” while leaving “quiet residential area” unselected. The terminal sends the selected candidate criteria to the server. The server registers the selected candidate criteria in the storage resource as part of the user's search conditions.

The server searches an information resource set based on the registered search conditions. The information resource set may be stored in the same relational database or in a specialized search index such as a full-text search engine. The server formulates a structured query including explicit criteria (for example, maximum rent, distance to station) and selected latent criteria (for example, pet-friendly, construction year condition). The server executes the query and retrieves matching information resources. The server can apply a ranking function that incorporates scores from the preference model so that items matching both explicit and latent criteria are ranked higher. This ranking reduces the number of irrelevant results and improves precision.

The server presents the search result to the user via the terminal. The server may include additional meta-information, such as indicators explaining why a given resource is recommended (“matches your preference for pet-friendly properties”). The server generates guidance information by constructing a further prompt sentence to the generative AI model that includes the search result context and the user's state. For example, the server may construct a prompt sentence such as: “Given that the user highly values proximity to the station, new buildings, and pet-friendly properties, and the following properties satisfy these criteria, generate polite guidance encouraging the user to review and possibly schedule a viewing for the top three properties.”

The server supplies this guidance prompt sentence to the generative AI model and receives natural language guidance text. The server then displays this guidance information on the terminal.

In another embodiment, the server performs emotion analysis on the user's input information and, optionally, the user's behavior patterns. The server uses a sentiment analysis model implemented as a neural network that maps textual inputs to emotion labels or continuous emotion scores. The sentiment analysis model may be trained using supervised learning with annotated sentiment data and optimized by minimizing a classification loss function. The server examines emotion features such as positivity, negativity, or stress indicators and includes these emotion scores as additional features in the preference model or directly within the prompt sentences. For instance, when the user expresses frustration in text such as “I can't find any good apartments,” the server detects a negative emotional state and adjusts its prompt sentences to request more reassuring and explanatory responses from the generative AI model. This emotion-aware adjustment improves the quality and appropriateness of system guidance.

The server achieves technical improvement over conventional systems by tightly integrating data preprocessing, feature engineering, machine learning-based preference extraction, and generative AI-based natural language prompting as a single pipeline. By normalizing numerical attributes and encoding categorical attributes into fixed-length vectors, the server reduces internal variance and noise of input features, which leads to faster convergence of models and improved predictive accuracy. By using a neural network with learned weights to infer preference tendencies from high-dimensional history data, the server can detect nonlinear relationships and interactions that cannot be captured by simple rule-based filters. The server thereby reduces errors in relevance estimation and improves ranking precision.

Furthermore, by converting learned criteria into explanatory information and re-injecting these explanations as part of the prompt sentences to the generative AI model, the server establishes a feedback loop between structured model outputs and natural language generation. This non-conventional loop enables the system to obtain machine-interpretable candidate criteria from a generative model, which are then stored and used as structured search conditions. As a result, the generative AI model is not merely used to output human-readable text, but is controlled and constrained by structured preference representations, leading to more consistent and technically useful outputs.

From a resource-usage perspective, the server reduces communication load and computation load by performing heavy preprocessing and model inference on the server side and by transmitting only condensed candidate lists and search results to the terminal. The structured preprocessing also allows incremental updates: when new user actions are recorded, the server can update only affected feature vectors and re-run preference inference on a subset of data, which reduces redundant computations. In some embodiments, the server caches intermediate representations such as user embeddings or cluster identifiers, further reducing processing time for subsequent sessions.

In a further embodiment, the server uses different machine learning architectures for different sub-tasks. For example, the server uses a feed-forward neural network for click-through prediction, a recurrent neural network or sequence model for modeling temporal sequences of user actions, and a transformer-based encoder for encoding text attributes of resources. The server concatenates or otherwise combines outputs from these sub-models to form a comprehensive user preference representation. This modular architecture allows the system to control independent hyperparameters and architectures for each sub-task, improving overall flexibility and enabling targeted optimization of accuracy and speed.

The described embodiments are not limited to real estate information resources. The server may apply the same technical pipeline to other information resource domains such as digital content, services, or product catalog items. The core technical features—structured preprocessing of history data, extraction of explicit and latent criteria using machine learning, construction of explanatory information, and prompt-driven interaction with a generative AI model to obtain candidate criteria and guidance—remain the same. Different embodiments may vary the specific feature sets, model architectures, and optimization strategies depending on the domain, while still benefiting from the same technical effects of improved accuracy, computational efficiency, and system adaptability.

Although particular embodiments have been described, the server, the terminal, and the user can interact through various communication protocols and device types, and different combinations of software libraries, machine learning frameworks, and generative AI deployments can be used without departing from the scope supported by the claims.

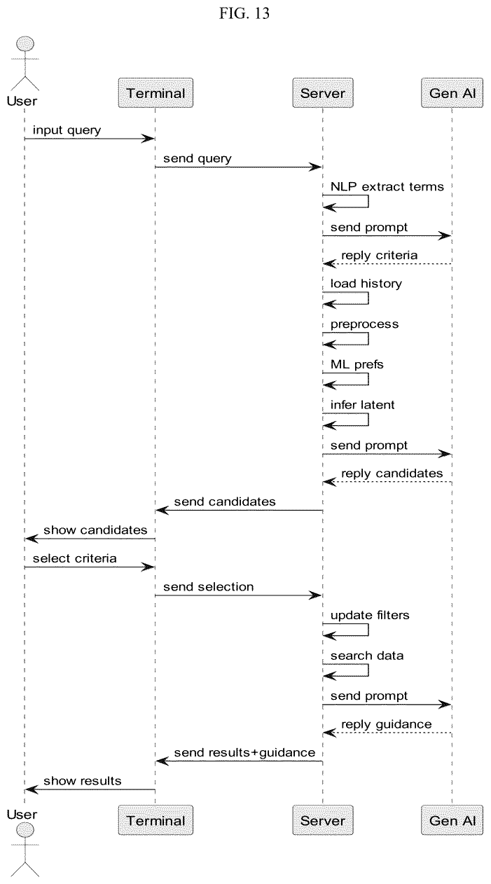

The following describes the processing flow using FIG. 13.

### Step 1

The user operates the terminal to input a natural language request.

The terminal receives, as input, a free-form text string from the user through an input control such as a keyboard or touchscreen. The terminal packages this text together with a user identifier and authentication token into a request message. The terminal outputs this request message and transmits it to the server via a network interface using a communication protocol such as HTTPS.

### Step 2

The server receives the natural language request and extracts important terms.

The server receives, as input, the request message containing the user identifier and the natural language text. The server applies a natural language processing pipeline that includes tokenization, part-of-speech tagging, and syntactic parsing using a software library such as a general NLP toolkit. The server computes term importance scores based on factors such as term frequency, part-of-speech category, and syntactic role, and filters out stop words and non-informative tokens. On the basis of these computations, the server outputs a list of important terms and associated weights that summarize the user's explicit request.

### Step 3

The server constructs a query sentence and supplies it as a prompt sentence to a generative AI model.

The server receives, as input, the list of important terms and the original natural language text. The server arranges these elements into a structured template that specifies the task for the generative AI model, such as extracting constraints or rewriting the request. The server concatenates the template text and the important terms to form a query sentence. The server outputs this query sentence and sends it as a prompt sentence to a generative AI model endpoint via an API call, including model parameters such as temperature and maximum output length.

### Step 4

The server receives and parses an initial response from the generative AI model.

The server receives, as input, a natural language response generated by the generative AI model in reply to the prompt sentence. The server analyzes the response to identify explicit criteria and meta-information, for example by scanning for bullet points, key phrases, or specific pattern markers. The server may apply additional natural language processing to normalize the wording and to map each linguistic phrase to an internal attribute key, such as “max_rent,” “distance_to_station,” or “sunlight_preference.” The server outputs a preliminary structured criteria object that encodes these attributes and their inferred priority levels.

### Step 5

The server acquires selection history and search history from the storage resource.

The server receives, as input, the user identifier from the initial request. The server executes database queries on a relational database management system to retrieve selection history records and search history records associated with the user. The selection history records include resource identifiers, timestamps, and action types such as “view,” “bookmark,” or “inquiry.” The search history records include past query texts, filter values, and sort options. The server aggregates the retrieved rows into in-memory collections, such as arrays of records. The server outputs a raw history data set containing all relevant past interactions of the user.

### Step 6

The server preprocesses the history data set into a machine-learning-ready form.

The server receives, as input, the raw history data set. The server performs duplicate detection by comparing user identifiers, resource identifiers, and timestamps, and removes redundant entries to avoid bias. The server scans each record for missing attribute values, such as missing price or area, and applies imputation rules based on global or segment-specific statistics (for example, median price per region). The server normalizes numerical attributes, such as rent, area, and distance, by subtracting mean values and dividing by standard deviations. The server encodes categorical attributes into numerical representations, such as one-hot vectors or integer indices. The server outputs a normalized feature matrix and corresponding metadata that describe the mapping between features and original attributes.

### Step 7

The server applies a machine learning model to extract preference tendencies.

The server receives, as input, the normalized feature matrix and, when available, labels indicating positive user actions (such as bookmarks). The server passes the feature matrix through a trained neural network or other machine learning model to compute predicted scores, such as probabilities that each interaction reflects a strong preference. The server computes feature contribution values by analyzing gradients, perturbation effects, or learned parameter magnitudes, and aggregates these contributions across all interactions of the user. On the basis of this aggregation, the server outputs a set of preference tendencies represented as a group of criteria, each criterion having an associated strength or weight that indicates its importance to the user.

### Step 8

The server infers latent criteria that are not explicitly specified by the user.

The server receives, as input, the group of criteria derived from the model and the explicit criteria generated from the initial natural language response. The server compares the two sets and identifies attributes with high preference weights that are not present among the explicit criteria. The server also detects compound patterns where combinations of features frequently appear in positively rated interactions, such as “quiet residential area” inferred from low traffic noise and side-street locations. The server performs this comparison and pattern detection using rule-based logic and thresholding on the aggregated contribution scores. The server outputs a list of latent criteria, each with an associated confidence level and an internal attribute representation.

### Step 9

The server converts the criteria into human-readable explanatory information.

The server receives, as input, the explicit criteria, the preference tendencies, and the latent criteria. The server maps each internal attribute, such as “distance_to_station≤10,” “construction_year≥threshold,” or “pet_allowed=true,” to a natural language phrase using a predefined phrase template library. The server then combines phrases and numeric thresholds into explanatory sentences, such as “You frequently select properties within a 10-minute walk from a station” or “You often view pet-friendly properties even when you do not set a pet-allowed filter.” The server outputs an explanatory text block that describes the user's preferences and inferred latent criteria in human-readable form.

### Step 10

The server constructs a second prompt sentence for the generative AI model using explanatory information.

The server receives, as input, the explanatory text block and the latent criteria list. The server inserts these elements into a structured prompt template that asks the generative AI model to analyze and refine the criteria. The server constructs a prompt sentence such as:

“The user has the following selection history and search history:
Often views properties within 10 minutes' walk from a station.
Frequently clicks and bookmarks newer properties (built within the last 5 years).
Sometimes opens pet-friendly properties, even when ‘pet allowed’ is not selected as a filter.

Based on these behaviors, analyze the criteria that the user values in choosing properties. Then, identify additional criteria that the user may care about but has not explicitly set as conditions. Return the result as a list of criteria with short explanations.”

The server outputs this composed prompt sentence and transmits it to the generative AI model as an input message.

### Step 11

The server receives refined candidate criteria and explanations from the generative AI model.

The server receives, as input, the generative AI model's response to the second prompt sentence. The response includes natural language descriptions of candidate criteria and explanations. The server parses the response by segmenting it into individual items, detecting list markers or numbering, and extracting criterion names and explanatory sentences. The server uses pattern matching and mapping tables to associate each described criterion with an internal attribute key. The server outputs a structured candidate criteria list containing attribute identifiers, human-readable labels, and explanation texts.

### Step 12

The server sends the candidate criteria list to the terminal for user selection.

The server receives, as input, the candidate criteria list and the user identifier. The server packages the candidate list into a response message that includes, for each candidate, an internal key, a display label, and an explanation. The server outputs this response message and transmits it to the terminal through the network interface, using a format suitable for the terminal's user interface rendering logic.

### Step 13

The terminal displays the candidate criteria and collects a selection operation from the user.

The terminal receives, as input, the candidate criteria list from the server. The terminal renders each candidate criterion as a user interface element, such as a switch, checkbox, or button, paired with its explanation text. The user reviews these candidate criteria and performs one or more selection operations to accept or reject them. The terminal records the user's selection state for each candidate and constructs a selection result object containing the accepted criteria keys and any user modifications. The terminal outputs this selection result object and transmits it back to the server.

### Step 14

The server registers the selected candidate criteria as search conditions.

The server receives, as input, the selection result object from the terminal, including the identifiers of accepted candidate criteria. The server updates the user's profile record in the storage resource to include these accepted criteria as persistent search conditions. The server merges the new criteria with any preexisting filters, resolving conflicts by applying predetermined precedence rules, such as giving priority to the most recent user selections. The server outputs an updated search condition set associated with the user identifier.

### Step 15

The server performs a search over the information resource set using explicit and latent criteria.

The server receives, as input, the updated search condition set and the current search request context. The server translates each criterion into a component of a structured query, such as range constraints, equality filters, or ranking modifiers, and constructs a compound query for the underlying database or search engine. The server executes this query against the information resource set stored in the storage resource and obtains a set of matching resources. The server optionally computes ranking scores using the preference model, combining explicit-criteria matching and latent-criteria importance. The server outputs a ranked search result list that reflects both explicit and latent criteria.

### Step 16

The server generates guidance information related to the search result.

The server receives, as input, the ranked search result list and the current preference and criteria summaries. The server constructs a guidance prompt sentence for the generative AI model that includes a summary of top results and the user's key criteria. The prompt sentence may request actions such as explaining why certain resources are recommended or suggesting next steps. The server sends this guidance prompt sentence to the generative AI model and receives back guidance text. The server outputs guidance information consisting of one or more natural language messages that encourage specific actions, such as viewing details, saving favorites, or scheduling a visit.

### Step 17

The terminal presents the search results and guidance information to the user.

The terminal receives, as input, the ranked search result list and the guidance information from the server. The terminal renders the search results as a list or grid of items, each with summary attributes and, optionally, indicators highlighting matched criteria. The terminal displays the guidance information alongside or above the results as textual prompts or call-to-action elements. The user reviews the presented information and may perform further actions, such as refining criteria, requesting more details, or initiating communication, which will be captured and fed back as new selection history and search history in subsequent iterations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation and search systems generally map user inputs directly to predefined filters or fixed query templates. In such systems, a processor typically interprets a user's text or selection as a static set of criteria and executes a database search accordingly. This architecture suffers from several technical limitations in terms of information processing performance and flexibility. First, the processor is unable to robustly handle unstructured, ambiguous, or emotionally loaded natural-language input, because the system does not transform the input into a rich machine-interpretable representation that captures higher-level concepts and latent user preferences. As a result, the system often generates low-quality ranking signals and inefficient query plans, leading to suboptimal use of storage and processing resources.

Second, conventional systems do not jointly exploit heterogeneous data sources, such as natural-language content, behavioral history, and emotional state, within a unified processing pipeline. Behavioral data (for example, selection history and search history) and affective signals are either ignored or used in a simplistic, rule-based manner. This causes the processor to fail to adapt search criteria dynamically, which degrades the relevance of retrieved items and requires repeated user interaction and additional queries to find desired information. Consequently, the overall throughput of the information retrieval pipeline decreases, and network and compute resources are wasted on repeated or redundant operations.

Third, in many existing architectures, any use of machine learning or generative models is isolated from the core query-processing path. A generative model, when used, is typically invoked only to generate surface-level content, such as explanatory text, and is not tightly integrated with the internal representation of criteria and control logic. This separation prevents the processor from using generative models to construct, refine, and re-parameterize machine-readable prompts and evaluation criteria in a closed loop. As a result, the system cannot efficiently optimize recommendation logic on a per-user basis over time, and cannot adapt query structures or ranking functions to reflect changing user preferences or emotional context.

Fourth, user interfaces in conventional systems typically act as passive display layers that present static recommendation results. The processor does not treat the interface as an active part of an adaptive information-processing pipeline. The absence of an interactive dialogue interface driven by dynamically generated prompts prevents the system from progressively reducing uncertainty about user intent. This leads to more round-trips between client and server, redundant data transfers, and additional computation to repeatedly process poorly specified queries.

Therefore, there is a need for a technical solution that improves the way a processor in an information processing system acquires, represents, and updates user criteria by integrating natural language processing, behavioral-history analysis, emotion analysis, and generative models. Such a solution should enable the processor to construct higher-level-concept representations and prompt sentences suitable for generative AI models, to dynamically adjust evaluation criteria in real time, and to drive an interactive interface that converges more quickly on relevant information. By doing so, the system can improve the efficiency, adaptability, and quality of computer-implemented recommendation and search processing, reduce unnecessary computation and network usage, and provide technically enhanced behavior compared with conventional systems.

The specific processing by the specific processing unit 290 of the data processing device 12 in Application Example 2 is realized by the following means.

The present invention provides a server comprising a processor configured to receive user input information expressed in natural language, apply a natural language processing technique to analyze linguistic components of the user input information, and extract keywords represented as higher-level concepts; to construct a prompt sentence for a generative AI model based on the extracted keywords and user attribute information, and input the prompt sentence together with user data into the generative AI model so as to generate evaluation-criteria information corresponding to preference criteria or requirement conditions of the user; to store behavioral-history information including selection-history information and search-history information of the user, apply a machine-learning algorithm to the behavioral-history information to identify evaluation criteria and latent needs of the user represented as higher-level concepts, and organize and refine the evaluation-criteria information; to execute an emotion-analysis process by using an emotion-analysis engine on natural-language responses and operation information obtained from the user, estimate an emotional state of the user, and adjust at least one of weighting and priority of the evaluation-criteria information in accordance with the estimated emotional state; to search, on the basis of the adjusted evaluation-criteria information, information data including at least one of generic information data, product data, and service data stored in an information storage device, and combine a search result with a prompt sentence for input to the generative AI model so as to generate guidance prompts including candidate information to be presented to the user and recommendation reasons for the candidate information; to transmit the guidance prompts and the candidate information to a user terminal and, via display control at the user terminal, realize an interactive dialogue interface configured to induce a specific action from the user; and to dynamically update the prompt sentence and the evaluation-criteria information in accordance with additional input information acquired from the user terminal and with a change in user preferences, and input an updated prompt sentence again into the generative AI model so as to sequentially optimize at least one of a recommendation result and a search result. This enables the server to internally represent user intent as machine-interpretable, higher-level evaluation criteria that are continuously refined by natural language processing, behavioral-history analysis, emotion analysis, and generative AI feedback, thereby improving the efficiency and adaptability of computer-implemented recommendation and search operations, reducing redundant query processing, and enhancing the relevance and convergence speed of system outputs compared with conventional systems.

The term “user input information” refers to information expressed in natural language or through user operations that is provided by a user to the system and received by the processor for analysis.

The term “natural language processing technique” refers to a computational technique for analyzing human language text, including at least one of tokenization, part-of-speech tagging, syntactic or semantic parsing, keyword extraction, and entity recognition, in order to obtain a machine-interpretable representation.

The term “linguistic components” refers to structural elements of natural-language text, including at least words, phrases, clauses, and sentences, as recognized and processed by the natural language processing technique.

The term “keyword” refers to an element extracted from user input information that represents a salient concept, attribute, or intent, and that is used by the processor as a feature for subsequent analysis or search processing.

The term “higher-level concept” refers to an abstracted representation of user intent or preference, generalized beyond specific surface words or items, such as a category, theme, or evaluation viewpoint inferred from user input information.

The term “user attribute information” refers to user-related data such as demographic information, profile information, device information, or account information that can be associated with the user and used as context for analysis.

The term “prompt sentence” refers to a text sequence constructed by the processor and supplied as an input instruction to a generative AI model to specify a task, provide context, or constrain the output of the generative AI model.

The term “generative AI model” refers to a machine learning model configured to generate output data, such as text or structured information, based on input data including at least one of a prompt sentence, feature vectors, and context information.

The term “user data” refers to data associated with the user, including at least one of user attribute information, behavioral-history information, preference information, and interaction logs.

The term “evaluation-criteria information” refers to information representing criteria, weights, or conditions used by the processor to evaluate, filter, or rank information data, including at least user preference criteria and requirement conditions.

The term “preference criteria” refers to evaluation viewpoints indicating what the user tends to favor, such as preferred categories, quality levels, or feature priorities.

The term “requirement conditions” refers to constraints or mandatory conditions specified or inferred for the user, such as ranges, thresholds, or inclusion/exclusion conditions.

The term “behavioral-history information” refers to accumulated data describing past actions of the user within the system, including at least selection-history information and search-history information.

The term “selection-history information” refers to records of items, options, or content that the user has selected, clicked, bookmarked, purchased, or otherwise chosen in past interactions.

The term “search-history information” refers to records of search queries, filters, or retrieval operations previously executed by or on behalf of the user.

The term “machine-learning algorithm” refers to a computational procedure that adjusts internal parameters or learns patterns from data, including at least one of classification, regression, clustering, dimensionality reduction, and representation learning methods.

The term “latent needs” refers to user needs, preferences, or constraints that are not explicitly stated by the user but are inferred from behavioral-history information or other data.

The term “organize and refine” refers to processing evaluation-criteria information by structuring, consolidating, or updating it, including at least grouping related criteria, adjusting weights, and removing redundancies.

The term “emotion-analysis engine” refers to a software or hardware component configured to estimate an emotional state of the user based on user input information, including at least text analysis or interaction pattern analysis.

The term “emotional state” refers to an estimated affective condition of the user, such as positive, negative, neutral, stressed, relaxed, or similar descriptors, as determined by the emotion-analysis engine.

The term “weighting” refers to assigning numeric or relative importance values to elements of evaluation-criteria information, which influence ranking, selection, or filtering operations.

The term “priority” refers to an order of precedence assigned to elements of evaluation-criteria information, used to control which criteria are emphasized during search or recommendation processing.

The term “information storage device” refers to a storage component, such as a memory device or storage subsystem, that stores information data including at least generic information data, product data, and service data.

The term “information data” refers to data items stored in the information storage device that can be retrieved and presented to the user, including at least generic information data, product data, and service data.

The term “generic information data” refers to data items representing general informational content, such as textual documents, articles, or records not limited to a specific product or service.

The term “product data” refers to data items representing goods or tangible items, including attributes such as category, specification, price, and description.

The term “service data” refers to data items representing services or activities, including attributes such as service type, conditions, fees, and descriptions.

The term “search result” refers to a set of information data items retrieved by the processor from the information storage device based on evaluation-criteria information.

The term “guidance prompt” refers to a prompt sentence generated by the processor that includes candidate information and recommendation reasons, and that is designed to guide or induce a specific action from the user.

The term “candidate information” refers to one or more information data items, product data items, or service data items selected by the processor as potential options to be presented to the user.

The term “recommendation reason” refers to explanatory information indicating why particular candidate information has been selected or ranked, often referencing evaluation-criteria information.

The term “user terminal” refers to a computing device operated by the user, such as a client device, through which the user sends input information and receives output information from the server.

The term “display control” refers to processing performed to control presentation of information on the user terminal, including at least layout, order, emphasis, and timing of displayed content.

The term “interactive dialogue interface” refers to a user interface that supports multi-turn exchanges between the user and the system, where prompts, responses, and updates are dynamically generated and displayed.

The term “specific action” refers to an action that the system intends to induce the user to perform, including at least selecting an item, confirming a choice, initiating a transaction, or refining criteria.

The term “additional input information” refers to new information received from the user or the user terminal after an initial interaction, including at least follow-up responses, further selections, or modified criteria.

The term “change in user preferences” refers to an alteration over time in the user's preference profile as inferred from new behavioral-history information or explicit input.

The term “updated prompt sentence” refers to a prompt sentence that has been modified by the processor to reflect additional input information or a change in user preferences.

The term “recommendation result” refers to an output of the system that includes candidate information selected and ranked for presentation to the user based on evaluation-criteria information.

The term “sequentially optimize” refers to improving at least one of the recommendation result and the search result over multiple iterations by repeatedly updating evaluation-criteria information and prompt sentences and re-invoking the generative AI model.

The term “information domain” refers to a category or field of information, such as entertainment, commerce, or real estate, in which information data or services are organized.

The term “service category” refers to a classification of services into types or groups, such as recommendation service, search service, or communication service.

The term “related service” refers to a service determined by the processor to be relevant to the user's input information, behavioral-history information, or emotional state.

The term “action-inducing prompt” refers to a prompt sentence specifically designed to encourage the user to perform a certain operation or to move forward in a workflow based on evaluation-criteria information and emotional state.

In the following description, the subject of each sentence is the server, the terminal, or the user.

The server comprises at least one processor, a memory, and a communication interface connected to a network.

The server executes an operating system and application software modules implementing natural language processing, machine learning, generative AI model inference, emotion analysis, and database access.

The server stores information data, including generic information data, product data, and service data, in one or more storage subsystems such as relational databases and document stores.

The terminal comprises a computing device such as a mobile terminal or a personal computer, executing a client application or a web browser that communicates with the server via the network.

The user operates the terminal to input natural-language text and to view output information presented by the server.

The server uses natural language processing software, such as a library for tokenization, part-of-speech tagging, syntactic parsing, and named-entity recognition, to convert raw text strings received from the terminal into token sequences and linguistic feature structures.

The server uses additional software modules implementing vectorization (for example, word embedding generation and contextual representation calculation) to represent words, phrases, and sentences as numerical feature vectors.

The server stores these vectors in memory as multi-dimensional arrays associated with metadata such as user identifiers, timestamps, and message types.

The server applies a keyword extraction algorithm to the linguistic feature structures and embeddings.

The server uses, for example, a combination of term-frequency analysis, attention weight aggregation from a pre-trained language encoder, and rule-based filters to identify tokens and phrases that correspond to higher-level concepts.

The server maps low-level tokens to higher-level concepts using a concept hierarchy stored in a knowledge base or ontology, which the server loads into memory as graph-structured data.

The server thereby generates a set of concept identifiers and weights that represent the essence of the user input information in a machine-interpretable form.

The server constructs a prompt sentence for a generative AI model by combining the extracted higher-level concepts, user attribute information, and any previously determined evaluation-criteria information.

The server uses a template-based prompt generator that inserts concept names, attribute values, and contextual descriptions into natural-language templates stored in the memory.

The server may generate, for example, a prompt sentence such as: “Analyze the user's purchase history and browsing history, identify the criteria the user values, and propose related products.”

The server may generate another prompt sentence such as:

“User profile: office worker, frequently selects outdoor products and camping items. Analyze this history and identify deeper preference criteria and potential latent needs.”

The server supplies the prompt sentence and associated feature vectors to a generative AI model.

The server implements the generative AI model as a neural network model deployed on an inference engine, for example, a transformer-based sequence-to-sequence architecture.

The server represents model inputs as tensor objects containing token indices, positional encodings, and numerical features corresponding to user attributes and evaluation criteria.

The server feeds these tensors into the generative AI model by invoking a model-inference API that executes on a computation subsystem optimized for matrix operations.

The server configures the generative AI model with a plurality of layers, each comprising attention sub-layers and feedforward sub-layers, and with parameters pre-trained on a large corpus of text and optionally fine-tuned on domain-specific interaction logs.

The server uses an objective function such as cross-entropy loss during training and adjusts the model parameters by an optimization algorithm such as stochastic gradient descent with adaptive learning rate.

The server stores learned model weights in persistent storage and loads them into memory when executing inference.

The server uses these weights to compute output token probabilities conditioned on the input prompt sentence and context.

The server receives the output sequence generated by the generative AI model and parses the sequence to extract structured evaluation-criteria information and action-inducing prompts.

The server may, for example, interpret specific tokens as labels for criteria dimensions (such as “commute_time_importance: high” or “pet_friendly: required”) and convert them into internal data structures stored as key-value maps.

The server thereby obtains evaluation-criteria information that can be directly applied to search queries and ranking functions, rather than merely displaying text to the user.

The server additionally stores behavioral-history information, including selection-history information and search-history information, in a structured database.

The server represents each history record as a row in a table including a user identifier, item identifier, action type, timestamp, and associated attributes.

The server uses a machine-learning algorithm, such as a clustering algorithm or a factorization-based recommender, to analyze the behavioral-history information.

The server constructs feature matrices where rows represent users and columns represent item attributes or interactive events, and the server computes latent factors that capture patterns of user preference across the population.

The server combines the latent factors derived from the history analysis with the evaluation-criteria information derived from the generative AI model.

The server uses a feature-fusion module that performs operations such as weighted averaging, concatenation, and dimensionality reduction to produce a consolidated criteria vector.

The server adjusts weights in this criteria vector dynamically by taking into account the estimated emotional state of the user.

The server estimates the emotional state by applying an emotion-analysis engine to natural-language responses and interaction signals received from the terminal.

The server may use, for example, a classifier based on a neural network model that receives sentence embeddings and outputs emotion labels such as “positive”, “negative”, “stressed”, or “relaxed”, along with confidence scores.

The server tunes the classifier using supervised learning on labeled emotion data and uses a loss function such as categorical cross-entropy to train the classifier.

The server thereby obtains real-time emotion signals that are not available in conventional rule-based systems.

The server adjusts weighting and priority of individual criteria elements according to the emotional state.

The server, for example, increases the weight of relaxation-related criteria when the emotion-analysis engine determines that the user is stressed, or increases the weight of commute-time criteria when the user expresses strong concern about commuting.

The server stores the weights in a structured array indexed by criteria identifiers, and the server uses these weights to parameterize subsequent query generation and ranking procedures.

The server executes search operations over the information storage device using the consolidated and emotion-adjusted evaluation criteria.

The server constructs structured queries, such as parameterized statements or vector search requests, that reference the criteria vector directly.

The server may, for example, query a relational database by mapping criteria into filter conditions and order-by clauses, or query a search index by mapping criteria into retrieval parameters and scoring functions.

The server retrieves candidate information data, product data, or service data that satisfy the evaluation criteria.

The server then combines the search result with a new prompt sentence for use with the generative AI model.

The server constructs, for example, a prompt sentence such as:

“Given the following candidate properties and the user's emphasis on commuting time within 30 minutes and pet-friendliness, generate a short explanation of why these properties are suitable.”

The server passes both the candidate data and the prompt sentence to the generative AI model, which outputs natural-language guidance prompts containing recommendations and reasons.

The server parses and stores these guidance prompts and associates them with respective candidate data.

The server transmits candidate information and guidance prompts to the terminal using a communication protocol such as HTTP over a secure transport.

The terminal receives the data and performs display control to present an interactive dialogue interface to the user.

The terminal displays, for example, a chat-like conversation where the user sees explanations such as “This apartment is recommended because it is within a 30-minute commute and allows pets,” and can respond with additional natural-language questions or modifications of criteria.

The user interacts with the interface not only by clicking static filters but also by entering free text describing preferences and reactions.

The server receives additional input information from the terminal as the user continues the interaction.

The server updates the evaluation-criteria information by re-running the natural language processing, behavior-model updating, and emotion-adjustment operations described above.

The server reconstructs an updated prompt sentence that encapsulates the new criteria and emotional context, and re-invokes the generative AI model with the updated prompt sentence.

The server thereby sequentially optimizes recommendation results and search results without requiring manual redefinition of queries by the user.

The server, in one embodiment, uses this architecture to control not only software-level recommendation logic but also resource allocation within the server infrastructure.

The server, for example, uses the criteria vector and emotion signals to prioritize caching of certain data subsets, to allocate computation resources (such as selecting between lightweight and heavyweight models), or to schedule batch training updates.

The server thereby reduces latency for high-priority queries, minimizes redundant computation by avoiding repeated processing of irrelevant content, and reduces network traffic by returning more relevant results in fewer communication rounds.

The server improves computer technology by introducing a non-conventional pipeline wherein generative AI models, emotion analysis, and behavior analysis are tightly integrated via structured prompt sentences and higher-level evaluation criteria.

The server does not merely automate human selection; instead, the server combines statistical representations, concept hierarchies, and dynamic weighting mechanisms that are difficult to replicate manually.

The server, for example, uses vectorized criteria and emotional weights to select optimized execution paths for database queries and to configure scoring functions, thus reducing the number of candidate items that must be processed in downstream stages.

The server reduces computation by pruning low-relevance candidates early using learned thresholds, and the server reduces storage access by focusing on data partitions inferred as high-value for the current user state.

The server achieves higher accuracy because the generative AI model uses context-rich prompt sentences that encode both user attributes and history-derived latent factors, rather than generic prompts.

The server improves convergence speed of the interaction because the interactive dialogue interface is guided by prompts that are adaptively generated to reduce uncertainty about user intent.

The server further lowers error rates in recommendation because emotion-driven weight adjustments correct for situations where explicit criteria alone would misrepresent the user's real priorities.

The server can implement alternative embodiments of the generative AI model and the emotion-analysis engine.

The server may, for example, use an encoder-decoder architecture with recurrent neural networks instead of a transformer, or may use a convolutional neural network followed by a recurrent layer for sequence modeling.

The server may vary the number of layers, hidden dimensions, and attention heads to trade off between computational cost and model capacity.

The server may also use different optimization algorithms, such as Adam or RMSProp, and may apply regularization techniques such as dropout or weight decay during training.

The server may augment training data through paraphrasing, back-translation, or noise injection, and may maintain separate models for different information domains, such as real estate, consumer products, and media content.

The server can similarly vary the machine-learning algorithm used to analyze behavioral-history information.

The server may use matrix factorization, neural collaborative filtering, graph-based recommendation, or clustering in a latent embedding space to derive user factors.

The server may store user factors in a dedicated embedding table and use fast nearest-neighbor search to identify similar users or items.

The server integrates these components into the criteria fusion process, resulting in a modular yet cohesive system that can be configured for different scales and domains.

The server, the terminal, and the user thereby cooperate to implement the invention in a manner that is reproducible and technically grounded.

The server executes precise algorithmic steps on specific data structures using designated software and hardware components.

The terminal mediates human-computer interaction in a way that exposes the technical benefits of the dynamic prompt, generative AI model, and emotion integration.

The user experiences improved responsiveness and relevance, while the underlying system achieves measurable improvements in processing efficiency, accuracy, and resource utilization compared with conventional systems that do not integrate these elements.

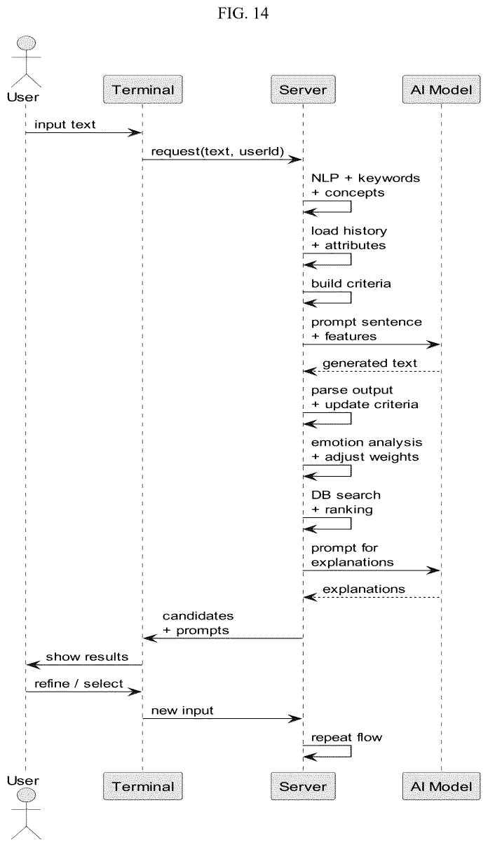

The following describes the processing flow using FIG. 14.

### Step 1

The terminal presents an input interface and acquires user input information expressed in natural language.

The user enters text such as a request, preference, or question, and confirms submission on the terminal.

The terminal generates a request message including at least the user identifier, the raw text string, and context metadata (timestamp, device type), and transmits the request message to the server via a network connection.

The input of this step is natural-language text entered by the user, and the output of this step is a structured request message delivered from the terminal to the server.

### Step 2

The server receives the request message from the terminal and extracts the user identifier, the raw text, and associated metadata.

The server applies a natural language processing technique, including tokenization and sentence segmentation, to the raw text to obtain a sequence of tokens and sentence boundaries.

The server further applies part-of-speech tagging and syntactic parsing to generate linguistic components such as dependency trees and phrase structures.

The input of this step is the raw natural-language text string, and the output of this step is a linguistic feature structure consisting of tokens, tags, and parse relations stored in memory.

### Step 3

The server performs keyword extraction and higher-level concept mapping based on the linguistic feature structure.

The server calculates term statistics, attention scores, or embedding similarities for each token or phrase and selects those with scores above a threshold as candidate keywords.

The server accesses a concept hierarchy or ontology stored in the information storage device and maps candidate keywords to higher-level concept identifiers by graph traversal and similarity comparison.

The input of this step is the linguistic feature structure from Step 2, and the output of this step is a set of higher-level concepts and associated weights represented in an internal data structure such as a key-value list or vector.

### Step 4

The server retrieves user attribute information and behavioral-history information corresponding to the user identifier from a database.

The server executes database queries to obtain selection-history information and search-history information, and loads these records into memory as structured tables or arrays.

The server applies a machine-learning algorithm, such as matrix factorization or clustering, to the history tables to compute latent user factors and preliminary evaluation-criteria candidates.

The input of this step is the user identifier and stored history records, and the output of this step is a latent-factor representation and an initial evaluation-criteria vector associated with the user.

### Step 5

The server fuses the higher-level concepts from Step 3 with the latent factors and initial evaluation criteria from Step 4.

The server performs data processing such as vector concatenation, normalization, and weighted averaging to produce a consolidated criteria vector.

The server stores this consolidated vector in memory as evaluation-criteria information that captures both explicit concepts from the current input and implicit preferences from behavioral history.

The input of this step is the set of higher-level concepts and the latent factors, and the output of this step is the consolidated evaluation-criteria information in vector or structured form.

### Step 6

The server constructs a prompt sentence to be supplied to a generative AI model by inserting higher-level concepts, user attributes, and elements of the evaluation-criteria information into a natural-language template.

The server selects a template based on the type of task (for example, recommendation, explanation, or clarification) and replaces placeholder tokens with actual concept names and attribute values.

The server may generate, for example, a prompt sentence such as “Analyze the user's purchase history and browsing history, identify the criteria the user values, and propose related products.” or

“User profile: frequently selects outdoor products and camping items. Analyze this history and identify deeper preference criteria and potential latent needs.”

The input of this step is the consolidated evaluation-criteria information and user attribute information, and the output of this step is a text-form prompt sentence prepared for the generative AI model.

### Step 7

The server converts the prompt sentence to a token sequence and encodes the sequence as numerical input tensors suitable for the generative AI model.

The server embeds tokens into vector representations and adds positional encodings and any auxiliary feature vectors representing user attributes or criteria weights.

The server invokes the generative AI model inference engine, providing input tensors and configuration parameters such as maximum output length and decoding strategy.

The input of this step is the prompt sentence and associated context features, and the output of this step is an output token sequence generated by the generative AI model.

### Step 8

The server decodes the output token sequence into text and parses the generated text to recover structured evaluation-criteria information and action-inducing prompts.

The server uses pattern matching, tagging, or a secondary parser to identify tokens representing criteria labels, values, and suggested actions.

The server updates the evaluation-criteria information by merging the newly generated criteria with the existing criteria vector, for example by adjusting weights or adding new dimensions.

The input of this step is the output token sequence from the generative AI model, and the output of this step is an updated set of evaluation-criteria information and at least one action-inducing prompt sentence.

### Step 9

The server receives additional input in the form of natural-language responses or operation logs from the user via the terminal and applies an emotion-analysis engine to this input.

The server encodes the text into sentence embeddings and feeds them into an emotion classifier that outputs emotion labels and confidence scores.

The server associates the emotion labels with the user session and stores emotion scores in a structure aligned with the evaluation-criteria dimensions.

The input of this step is the additional user responses and interaction data, and the output of this step is an estimated emotional state and corresponding numeric emotion weights.

### Step 10

The server adjusts the evaluation-criteria information using the emotion weights obtained in Step 9.

The server increases or decreases the weights of specific criteria elements by applying functions such as multiplicative scaling, bias addition, or softmax re-normalization.

The server thereby modifies the criteria vector so that criteria aligned with the current emotional state (for example, relaxation, commuting stress, or budget sensitivity) are emphasized in subsequent processing.

The input of this step is the previous evaluation-criteria vector and the emotion weights, and the output of this step is an emotion-adjusted evaluation-criteria vector.

### Step 11

The server generates search or retrieval parameters from the emotion-adjusted evaluation-criteria vector and constructs corresponding queries for the information storage device.

The server maps criteria dimensions to database fields or index terms and creates filter conditions, range constraints, and ranking functions.

The server sends the queries to storage subsystems such as relational databases or search engines and receives sets of candidate information data, product data, or service data.

The input of this step is the emotion-adjusted evaluation-criteria vector, and the output of this step is a collection of candidate items retrieved from storage.

### Step 12

The server computes relevance scores for the retrieved candidate items by applying scoring algorithms parameterized by the evaluation-criteria vector.

The server calculates, for each candidate, a weighted sum or learned scoring function that uses item feature vectors and criteria weights as inputs.

The server sorts candidate items according to their scores and selects a top subset to be presented as candidate information.

The input of this step is the retrieved candidate items and the evaluation-criteria vector, and the output of this step is a ranked list of candidate information items.

### Step 13

The server constructs guidance prompts that combine the ranked candidate information with explanation text generated by the generative AI model.

The server forms a new prompt sentence such as “Given the following candidate properties and the user's emphasis on commuting time within 30 minutes and pet-friendliness, generate a short explanation of why these properties are suitable.” and supplies this prompt sentence together with structured candidate attributes to the generative AI model.

The server receives generated explanation text and associates each explanation segment with a corresponding candidate item.

The input of this step is the ranked candidate list and a guidance-oriented prompt sentence, and the output of this step is a set of guidance prompts containing recommendations and reasons.

### Step 14

The server packages the candidate information and associated guidance prompts into a response message and transmits the response message to the terminal via the communication interface.

The terminal receives the response and parses the message into displayable structures representing items, scores, and explanations.

The terminal updates the user interface to present an interactive dialogue view and item list, allowing the user to read the guidance prompts and select or refine options.

The input of this step is the guidance prompts and candidate information generated by the server, and the output of this step is the displayed interactive interface on the terminal and the user's visual access to the recommended items.

### Step 15

The user observes the recommendations and explanations on the terminal and decides whether to perform a specific action such as selecting an item, modifying preferences, or entering follow-up questions.

The terminal captures the user's action as new input information and sends corresponding messages (for example, updated criteria or natural-language text) back to the server.

The server receives this additional input and, by returning to Step 2 through Step 10, iteratively refines the evaluation-criteria information and the prompt sentences, thereby sequentially optimizing recommendation and search results.

The input of this step is the displayed recommendations and guidance prompts, and the output of this step is new user interaction data that drives the next iteration of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

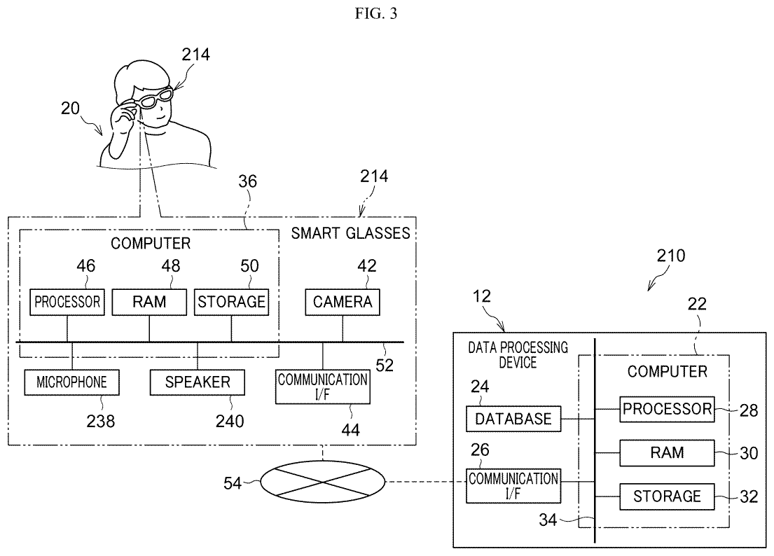

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

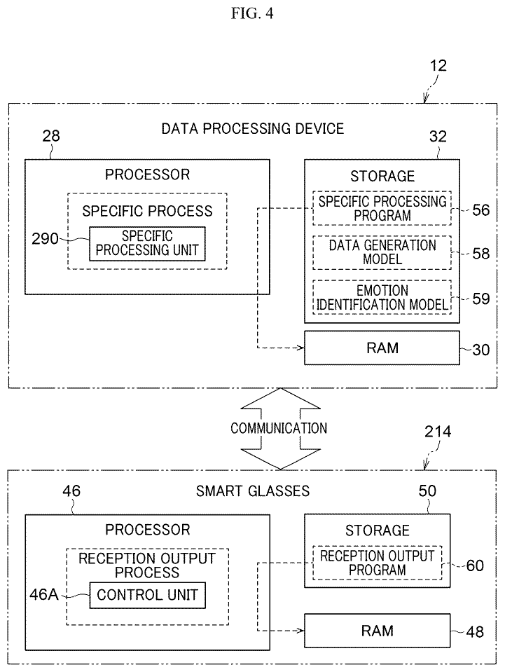

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

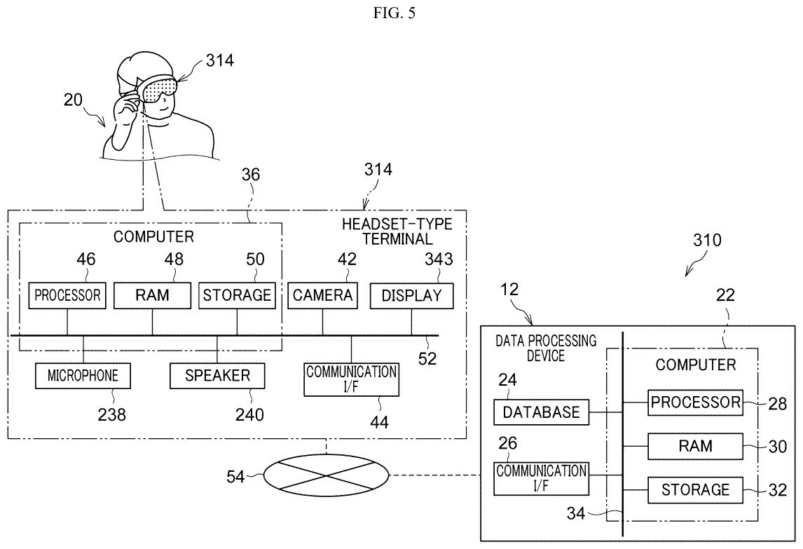

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

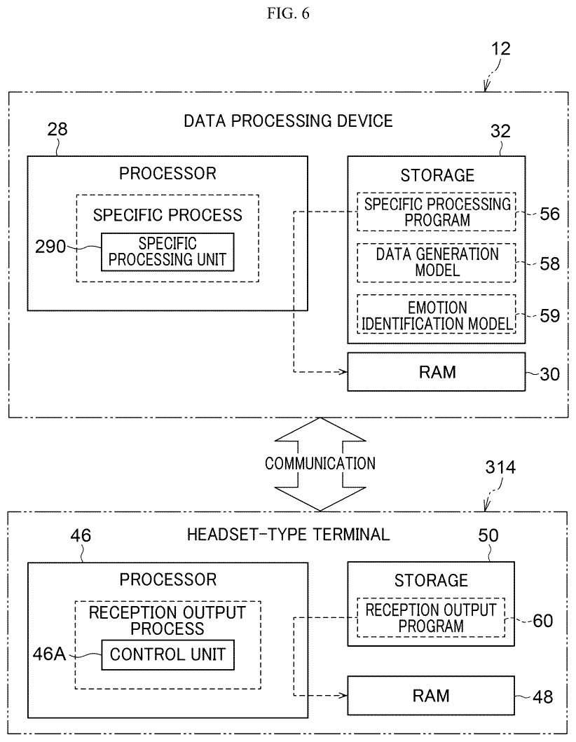

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

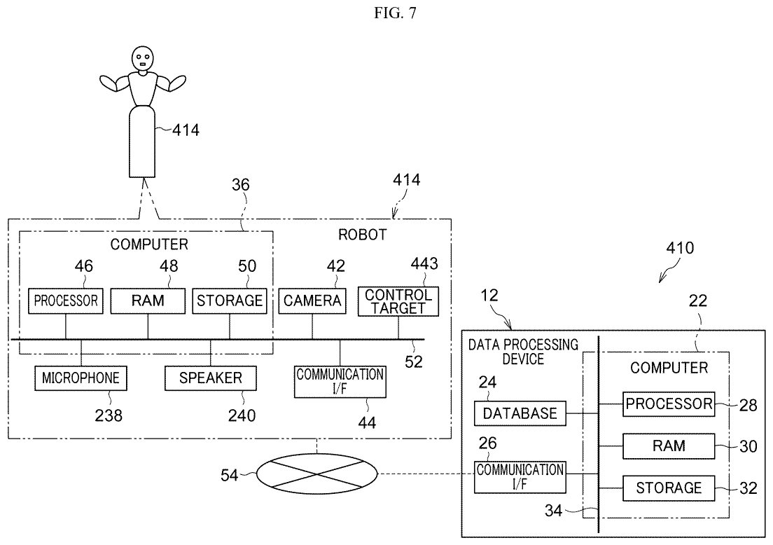

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

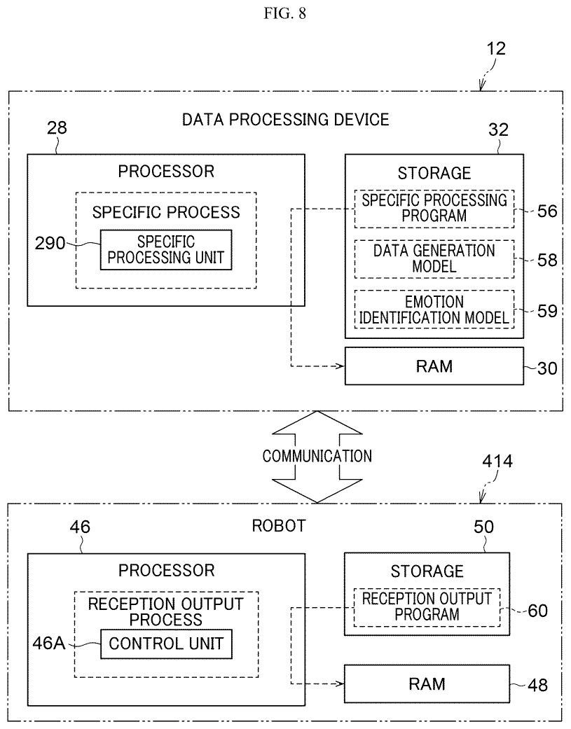

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

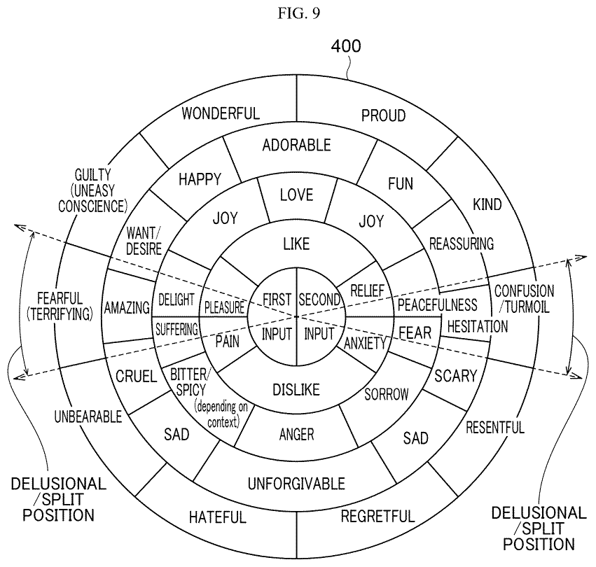

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

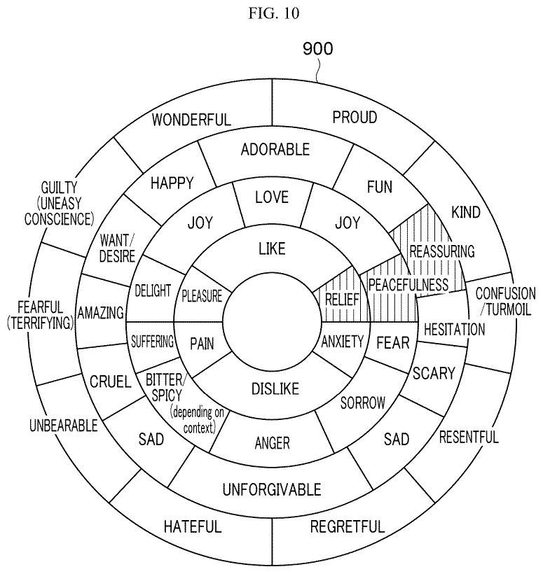

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive information from a user including natural language, analyze the information by using natural language processing to extract important terms including candidate criteria,
generate a prompt sentence for input to a generative AI model based on the extracted important terms and the candidate criteria, and obtain structured criterion information from the generative AI model,
generate a query sentence according to the criterion information, and execute a search process on an information storage apparatus having an index by using the query sentence to acquire information matching the criterion information,
generate display-structured information for split display of the acquired information and transmit the display-structured information to a terminal,
collect a selection history and a search history of the user, execute learning processing to organize and detail the criterion information, and automatically adjust the query sentence and the prompt sentence based on updated criterion information, and
analyze an emotional state of the user by using emotion analysis processing, adjust the criterion information and the display-structured information according to the emotional state, and generate a prompt to induce a specific action of the user.

### (Supplementary 2)

The system according to supplementary 1,
wherein the processor is configured to
form the prompt sentence to include instructions and an output format for extracting the criterion information from a natural language request, cause the generative AI model to output the criterion information using the prompt sentence and the natural language request as inputs, and integrate criteria obtained by form input with the natural language request to generate the query sentence.

### (Supplementary 3)

The system according to supplementary 1,
wherein the processor is configured to
determine, when converting the acquired information into the display-structured information, a number of display units, a display order, and guidance messages for detailed display according to the criterion information and the emotional state of the user, and cause the generative AI model to generate a prompt including candidate actions to be presented to the user by providing the emotional state and the criterion information to the generative AI model.

### Application Example 1

### (Supplementary 1)

A system comprising a processor,
wherein the processor is configured to
receive voice information and motion information from a user, convert the voice information and the motion information into character information and command information by using voice recognition processing and motion recognition processing, and acquire the converted character information and the converted command information as criterion information,
analyze the criterion information by using natural language processing, extract important keyword information including area information, price information, and condition information, convert the extracted keyword information into structured criterion information for database search, generate a query sentence for acquiring target information stored in an information storage device on the basis of the structured criterion information, and search the target information by using the query sentence, input the extracted keyword information and the structured criterion information to a generative model, and generate a prompt sentence including the query sentence for acquiring the target information, a normalization result of the criterion information, or supplementary condition information of the criterion information by using the generative model,
collect selection history information, search history information, and gaze information, fixation position information, or detail-display operation information of the user, analyze the collected history information by using a machine learning algorithm, generate user profile information and weighting information by organizing and deepening the criterion information of the user, and assign priority to and reconfigure a retrieval result of the target information on the basis of the user profile information and the weighting information,
analyze an emotional state of the user by using emotion analysis processing, adjust the criterion information or the user profile information on the basis of the emotional state, search related target information on the basis of the adjusted criterion information, and generate a prompt for urging the user to perform a specific action with respect to the related target information,
convert the prioritized target information and the prompt into presentation information for a display device, and display the presentation information in real time on a visual device including a head-mounted display, and
acquire motion information of the user from the display device, generate control information for updating the criterion information or display content of the target information by using the motion information, and perform re-search of the target information or acquisition of detailed information of the target information on the basis of the control information.

### (Supplementary 2)

The system according to supplementary 1,
wherein the processor is configured to
input a prompt sentence including the criterion information and data structure information to the generative model, acquire an output result including at least one of the query sentence for acquiring the target information, a parameterization result of the criterion information, and explanation information to be presented to the user from the generative model, and automatically execute a search process of the target information or a generation process of the presentation information on the basis of the output result.

### (Supplementary 3)

The system according to supplementary 1,
wherein the processor is configured to
input a prompt sentence to the generative model so as to cause the generative model to generate additional condition information or recommendation condition information corresponding to preference information and the emotional state of the user on the basis of the user profile information and the emotional state, integrate the additional condition information or the recommendation condition information output from the generative model into the criterion information, search the target information on the basis of the integrated criterion information, and display a retrieval result of the target information on the visual device.

### Example 2 (Supplementary 1)

A system comprising a processor and a storage resource,
wherein the processor is configured to
receive input information expressed in natural language from a user by using an input/output interface, and analyze the input information by using a natural language processing technique to extract one or more important terms representing requests of the user,
construct, on the basis of the one or more important terms, a query sentence to be input to a generative artificial intelligence model, and supply the query sentence to the generative artificial intelligence model so as to generate a prompt sentence for identifying one or more related information resources or one or more related functions,
acquire, from the storage resource, selection history information and search history information associated with the user, and perform preprocessing on the selection history information and the search history information, the preprocessing including data processing of removing duplicate information, complementing missing information, and normalizing numerical information, thereby generating a history data set in a format suitable for machine learning processing,
analyze the history data set by using a machine learning algorithm to extract a group of criteria representing consistent preference tendencies of the user in selection of information resources, and estimate, on the basis of the extracted group of criteria, one or more latent criteria that are not explicitly designated by the user,
convert the preference tendencies and the latent criteria into explanatory information in a human-readable format, and construct, by using the explanatory information, a prompt sentence for the generative artificial intelligence model so as to obtain, from the generative artificial intelligence model, response information including one or more candidate criteria to be presented to the user and reasons corresponding to the one or more candidate criteria,
construct, on the basis of the response information, a candidate list including the latent criteria, accept a selection operation of the user with respect to one or more candidate criteria included in the candidate list, and register the selected one or more candidate criteria as search conditions of the user in the storage resource,
search, on the basis of the registered search conditions, an information resource set stored in the storage resource to generate a search result that reflects explicit criteria and latent criteria of the user, and present the search result to the user by using the input/output interface, and generate, by using the generative artificial intelligence model, guidance information for prompting the user to perform a specific action related to the search result, and present the guidance information to the user by using the input/output interface.

### (Supplementary 2)

The system according to supplementary 1,
wherein the processor is configured to automatically determine, on the basis of the input information expressed in natural language received from the user and the history data set, one or more related information resources or one or more related functions, and automatically generate the query sentence and the prompt sentence to be input to the generative artificial intelligence model in accordance with a result of the determination.

### (Supplementary 3)

The system according to supplementary 1,
wherein the processor is configured to analyze an emotional state of the user by using an emotion analysis technique applied to the input information and the history data set, and include analysis results representing the emotional state in the prompt sentence supplied to the generative artificial intelligence model, thereby causing the generative artificial intelligence model to generate the latent criteria and the guidance information adjusted in accordance with the emotional state of the user.

### Application Example 2

### (Supplementary 1)

A system comprising a processor,
wherein the processor is configured to
receive input information expressed in natural language from a user and apply a natural language processing technique to the input information to analyze linguistic components and extract keywords represented as higher-level concepts,
construct a prompt sentence for input to a generative AI model based on the extracted keywords and user attribute information, input the prompt sentence and user data into the generative AI model, and generate evaluation-criteria information corresponding to preference criteria or requirement conditions of the user,
store behavioral-history information including selection-history information and search-history information of the user, apply a machine-learning algorithm to the behavioral-history information to identify evaluation criteria and latent needs of the user represented as higher-level concepts, and organize and deepen the evaluation-criteria information,
execute an emotion-analysis process on natural-language responses and operation information obtained from the user by using an emotion-analysis engine, estimate an emotional state of the user, and adjust at least one of weighting and priority of the evaluation-criteria information in accordance with the emotional state,
search, on the basis of the adjusted evaluation-criteria information, generic information data or product data or service data stored in an information storage device, combine a search result with a prompt sentence for input to the generative AI model, and generate guidance prompts including candidate information to be presented to the user and recommendation reasons for the candidate information,
transmit the guidance prompts and the candidate information to a user terminal and, via display control at the user terminal, realize an interactive dialogue interface that induces a specific action from the user, and
dynamically update the prompt sentence and the evaluation-criteria information in accordance with additional input information acquired from the user terminal and a change in user preferences, and input an updated prompt sentence again into the generative AI model so as to sequentially optimize at least one of a recommendation result and a search result.

### (Supplementary 2)

The system according to supplementary 1,
wherein the processor is configured to automatically generate the prompt sentence for input to the generative AI model as a higher-level-concept representation summarizing both the behavioral-history information and the emotional state of the user, automatically determine a related information domain or service category based on the prompt sentence, automatically select a related service from the input information of the user, and generate a recommendation prompt for the related service. (Supplementary 3)

The system according to supplementary 1,
wherein the processor is configured to embed the emotional state of the user, estimated by the emotion-analysis engine, as additional context information into the prompt sentence for the generative AI model, cause the generative AI model to generate evaluation-criteria information and action-inducing prompts consistent with the emotional state of the user, and perform at least one of information presentation and action inducement to the user in accordance with the emotional state.

What is claimed is:

1. A system comprising:
circuitry configured to:
receive input data from a terminal apparatus via a packet-switched network;
analyze the input data by applying a natural language processing algorithm to perform tokenization, part-of-speech tagging, and named entity recognition to extract one or more keyword data items from the input data;
construct a parameterized instruction sequence based on the one or more keyword data items, and provide the parameterized instruction sequence to a generative neural network model to cause the generative neural network model to generate resource identification data identifying one or more resources associated with the keyword data items;
acquire interaction history data and query history data associated with the entity from a storage medium, and apply a machine learning algorithm to the interaction history data and the query history data to compute refined criteria data representing inferred preferences and constraint parameters; and
compute emotion classification data based on the input data, adjust the refined criteria data based on the emotion classification data, and construct a response parameterized instruction sequence based on the adjusted refined criteria data to cause the generative neural network model to generate guidance data.

2. The system according to claim 1, wherein the natural language processing algorithm further performs dependency parsing and semantic role labeling on the input data to identify relational structures between the extracted keyword data items.

3. The system according to claim 2, wherein the circuitry is further configured to:
automatically determine a resource category from content of the input data based on the relational structures and the keyword data items, and incorporate the resource category into the parameterized instruction sequence to constrain the scope of the resource identification data generated by the generative neural network model.

4. The system according to claim 1, wherein the machine learning algorithm comprises a clustering algorithm that groups the interaction history data and the query history data into behavioral pattern clusters, and a classification model that assigns the entity to one or more behavioral pattern clusters based on recent interaction data.

5. The system according to claim 4, wherein the refined criteria data includes a preference vector comprising weighted attribute values computed by aggregating interaction frequency values and query recurrence values for each attribute across the interaction history data and the query history data.

6. The system according to claim 5, wherein the circuitry is further configured to:
apply a temporal decay function to the interaction history data and the query history data such that more recent interactions contribute higher weights to the preference vector than older interactions.

7. The system according to claim 1, wherein the emotion classification data is computed by applying an emotion analysis model to at least one of textual expression data extracted from the input data, acoustic feature data acquired from an acoustic transducer associated with the terminal apparatus, and visual feature data acquired from an imaging device associated with the terminal apparatus.

8. The system according to claim 7, wherein the emotion analysis model comprises a multi-layer neural network having an input layer, one or more hidden layers with non-linear activation functions, and an output layer that computes probability distributions over a set of emotion category labels.

9. The system according to claim 8, wherein the circuitry adjusts the refined criteria data by modifying weight values in the preference vector based on the emotion classification data, such that criteria associated with comfort or relaxation are prioritized when the emotion classification data indicates a stressed state, and criteria associated with novelty or challenge are prioritized when the emotion classification data indicates an engaged state.

10. The system according to claim 1, wherein the guidance data includes at least one of resource description data, contextual explanation data, and action suggestion data generated by the generative neural network model based on the adjusted refined criteria data and the resource identification data.

11. The system according to claim 10, wherein the circuitry is further configured to:
search an information repository based on the adjusted refined criteria data and the resource identification data to acquire supplementary information data, and incorporate the supplementary information data into the response parameterized instruction sequence to cause the generative neural network model to generate enriched guidance data.

12. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

13. The system according to claim 12, wherein the circuitry is further configured to:
generate a plurality of candidate guidance data items by providing the response parameterized instruction sequence with variation parameters, rank the candidate guidance data items based on alignment scores computed against the adjusted refined criteria data, and select a top-ranked guidance data item for transmission to the terminal apparatus.

14. The system according to claim 1, wherein the circuitry is further configured to:
receive feedback data from the terminal apparatus indicating acceptance or rejection of the guidance data, update the interaction history data in the storage medium based on the feedback data, and use the updated interaction history data to refine subsequent computation of the refined criteria data.

15. The system according to claim 14, wherein the circuitry is further configured to:
retrain or update parameters of the machine learning algorithm based on the accumulated feedback data to improve accuracy of the refined criteria data computation over time.

16. The system according to claim 1, wherein the circuitry is further configured to:
monitor a sequence of input data items received over a session, detect changes in emotion classification data between successive input data items, and proactively adjust the refined criteria data and regenerate the guidance data in response to detected emotional state transitions.

17. The system according to claim 16, wherein the proactive adjustment includes constructing a new response parameterized instruction sequence that explicitly references the detected emotional state transition and instructs the generative neural network model to generate guidance data appropriate for the transitioned emotional state.

18. A system comprising:
circuitry configured to:
receive, via a communication interface coupled to a packet-switched network, input data from a terminal apparatus;
apply a natural language processing algorithm to extract keyword data items from the input data, and construct a parameterized instruction sequence based on the keyword data items for a generative neural network model having a transformer-based architecture including a plurality of self-attention layers to generate resource identification data;
acquire interaction history data and query history data from a storage medium, apply a machine learning algorithm to compute refined criteria data representing inferred preferences;
compute emotion classification data by applying an emotion analysis model to expression data derived from the input data, and adjust the refined criteria data based on the emotion classification data; and
construct a response parameterized instruction sequence based on the adjusted refined criteria data and the resource identification data, and provide the response parameterized instruction sequence to the generative neural network model to generate guidance data for transmission to the terminal apparatus.

19. The system according to claim 18, wherein the circuitry is further configured to:
receive feedback data from the terminal apparatus, update the interaction history data based on the feedback data, and refine subsequent refined criteria data computation to improve guidance data relevance over successive interactions.

20. A method performed by circuitry, the method comprising:
receiving input data from a terminal apparatus via a packet-switched network;
analyzing the input data by applying a natural language processing algorithm to perform tokenization, part-of-speech tagging, and named entity recognition to extract one or more keyword data items from the input data;
constructing a parameterized instruction sequence based on the one or more keyword data items, and providing the parameterized instruction sequence to a generative neural network model to cause the generative neural network model to generate resource identification data identifying one or more resources associated with the keyword data items;
acquiring interaction history data and query history data associated with the entity from a storage medium, and applying a machine learning algorithm to the interaction history data and the query history data to compute refined criteria data representing inferred preferences and constraint parameters; and
computing emotion classification data based on the input data, adjusting the refined criteria data based on the emotion classification data, and constructing a response parameterized instruction sequence based on the adjusted refined criteria data to cause the generative neural network model to generate guidance data.
